(19) United States
(12) Patent Application Publication
(10) Pub. No.: US 2002/0101900 A1
(43) Pub. Date: Aug. 1, 2002

(54) Molecular fluorine laser with single spectral line and polarized output

(75) Inventors: Sergei V. Govorkov, Boca Raton, FL (US); Gongxue Hua, Fort Lauderdale, FL (US)

Correspondence Address: Andrew V. Smith, Sierra Patent Group, Ltd., P.O. Box 6149, Stateline, NV, 89449, US

(73) Assignee: Lambda Physik AG

(21) Appl. No.: 10/001,217

(22) Filed: Nov. 30, 2001

Related U.S. Application Data
(60) Provisional application No. 60/249,357, filed on Nov. 16, 2000.
(60) Provisional application No. 60/267,567, filed on Feb. 9, 2001.

(51) Int. Cl. H01S 3/22; H01S 3/223

(52) U.S. Cl. 372/57

(57) ABSTRACT

A molecular fluorine laser system includes a discharge chamber filled with a gas mixture at least including molecular fluorine and a buffer gas, multiple electrodes within the discharge chamber and connected to a discharge circuit for energizing the gas mixture, and a resonator for generating an output beam. The resonator includes at least one wavelength selection optic for selecting a primary line among multiple characteristic photoemission lines around 157 nm including suppressing a secondary line among the plurality of characteristic photoemission lines around 157 nm to below 1%. The resonator further includes at least one polarizing optic for polarizing the selected line so that the output beam has a polarization of at least substantially 95%, and preferably 97.5% or more.

### PRIORITY

This application claims is a Continuation-in-Part application which claims the benefit or priority to United States patent application serial number not yet assigned, entitled, “Molecular Fluorine Laser with Single Spectral Line and Polarized Output” of inventors Sergei V. Govorkov and Gongxue Hua, filed Nov. 6, 2001, which claims the benefit of priority to U.S. provisional patent application No. 60/249,357, filed Nov. 16, 2000, and No. 60/267,567, filed Feb. 9, 2001.

### BACKGROUND OF THE INVENTION

1. Field of the Invention

The invention relates to a molecular fluorine (F₂) laser, and particularly to a F₂ laser for generating an output beam including a single, polarized spectral line.

2. Discussion of the Related Art

Molecular fluorine lasers are capable of providing high power output at a wavelength of approximately 157 nm. For this reason, they are considered as a potential source for DUVNUV (deep/vacuum ultraviolet) microlithography with resolution below 100 nm. It is recognized in this invention that three parameters of the output beam generated by this laser that are of concern include output power, degree of polarization and spectral purity, wherein the latter involves at least single spectral line operation. It is therefore desired to provide a F₂ laser system for generating an output beam including substantially only a single spectral line around 157 nm and exhibiting a high degree of polarization at sufficient output power for lithographic processing applications.

### RECOGNIZED IN THE INVENTION

Free-running molecular fluorine lasers naturally emit at least two spectral lines (and there may be three-six lines or more in some configurations as detailed at U.S. Pat. Nos. 6,154,470 and 6,157,662, and at U.S. patent application No. 60/309,939, which is assigned to the same assignee as the present application, each of which is hereby incorporated by reference). The two most pronounced lines are positioned approximately 106 pm apart near 157 nm, e.g., at around 157.629 nm and 157.523 nm, with each line being typically less than around 1 pm wide. Therefore, in order to provide an output beam with high spectral purity, it is desired to suppress the weaker line and generate as much as possible of the stronger line. Wavelength-selective optical components may be disposed in the resonator of the F₂ laser to achieve this desired line-selection.

Moreover, the free-running F₂ laser emits an essentially unpolarized output. Therefore, in order to increase the degree of polarization, one or more polarizing optical components may be included in the resonator. These additional wavelength selection and/or polarization components can serve to significantly reduce the output power of the laser, for at least two reasons. First, each optical component has bulk and surface absorption at this short wavelength. Surface absorption originates from common contaminants such as hydrocarbons, water and oxygen, as well as traces of polishing compounds used in manufacturing. Even in the absence of contaminants, each optical surface gives rise to reflective (Fresnel) optical losses, unless the surface is anti-reflectively coated or oriented at the Brewster angle to the beam. Additionally, surface scattering losses are significant at this short wavelength. Secondly, with the addition of optical components, the optical path length in the resonator will typically be increased, which leads to reduced output power due to the short lifetime of the optical gain in molecular fluorine.

### SUMMARY OF THE INVENTION

In view of the above, a method of generating a laser output beam around 157 nm using a molecular fluorine laser system including a discharge chamber filled with a gas mixture at least including molecular fluorine and a buffer gas, multiple electrodes within the discharge chamber and connected to a discharge circuit for energizing the gas mixture and a resonator is provided. The method includes operating the molecular fluorine laser system to generate the 157 nm output beam at a desired energy for exposing an application workpiece, selecting a primary line among multiple characteristic photoemission lines around 157 nm of the molecular fluorine laser system including suppressing a secondary line among the multiple characteristic photoemission lines around 157 nm to below 1%, and polarizing the selected line so that the output beam has a polarization of at least substantially 95% when the beam exits the laser system, and preferably 97.5% or better.

A wavelength selection optic of the resonator may include a non-birefringent prism, and the non-birefringent prism may be a dispersive, Brewster prism and may be a half-prism. The resonator may also include one or more polarizing optics for polarizing the selected line. The one or more polarizing optics may include a birefringent prism, and the birefringent prism may be a dispersive, Brewster prism and it may be a half-prism. A polarizing optic may be alternatively or additionally provided extra-cavity for polarizing the beam.

The resonator may include an output coupler that seals the discharge chamber. The resonator may further include a lens for correcting a wavefront curvature of the beam. The lens may preferably be disposed in the resonator between an active discharge region of the discharge chamber and the wavelength selection optic. The lens may seal the discharge chamber or be disposed outside a window of the discharge chamber. The lens may be disposed with at least one surface oriented at least approximately at Brewster's angle to the beam. The lens may include at least one surface having an antireflection coating formed thereon. The resonator may include a beam expander, and the lens may be disposed in the resonator between the beam expander and the wavelength selection optic.

A dispersive Brewster prism may be disposed in the resonator for selecting the primary line including suppressing the secondary line among the multiple characteristic photoemission lines around 157 nm, and also for polarizing the selected line of the output beam. The Brewster prism may be formed of MgF₂, or another birefringent material, if any, having substantial transmissivity around 157 nm. The resonator may include a second dispersive prism in addition to the birefringent, dispersive Brewster prism. This second dispersive prism may be (at least substantially) non-birefringent, e.g., being formed of CaF₂. Either prism may be configured including a surface with a reflecting coating formed thereon as a resonator reflector surface.

The dispersive Brewster prism may also be non-birefringent, while the resonator further includes an additional prism that is birefringent. The birefringent prism may include a surface with a reflecting coating formed thereon as a resonator reflector surface.

The resonator may include at least one intra-cavity Brewster plate for polarizing the selected line of the output beam. The resonator may include two or three or more such Brewster plates. One or both windows on the discharge chamber may be a Brewster window for polarizing the output beam.

### BRIEF DESCRIPTION OF THE DRAWINGS

FIG. 1a schematically illustrates a resonator including a wavefront compensation lens and a dispersive prism of a molecular fluorine laser system according to a preferred embodiment.

FIG. 1b schematically illustrates a resonator including a dispersive prism and a wavefront compensation lens which seals the discharge chamber of a molecular fluorine laser system according to another preferred embodiment.

FIG. 2 schematically illustrates a birefringent, dispersive prism of a molecular fluorine laser system according to another preferred embodiment.

FIG. 3a schematically illustrates a resonator including a stack of Brewster plates, a wavefront compensation lens and a dispersive prism of a molecular fluorine laser system according to a preferred embodiment.

FIG. 3b schematically illustrates an alternative configuration of the resonator configuration of FIG. 3a.

FIG. 4a schematically illustrates a resonator including a birefringent prism including a resonator reflecting surface of a molecular fluorine laser system according to another preferred embodiment.

FIG. 4b schematically illustrates the birefringent prism of FIG. 4a.

FIG. 5a schematically illustrates an extra-cavity polarizer of a molecular fluorine laser system according to another preferred embodiment.

FIG. 5b schematically illustrates the extra-cavity polarizer of FIG. 5a.

FIG. 5c schematically further illustrates the extra-cavity polarizer of FIG. 5a.

FIG. 6a schematically illustrates a resonator including a wavefront compensation lens, a dispersive prism and a birefringent prism of a molecular fluorine laser system according to another preferred embodiment.

FIG. 6b schematically illustrates an alternative configuration of the resonator of FIG. 6a.

FIG. 7a schematically illustrates a resonator including a wavefront compensation lens, a dispersive, birefringent prism and a dispersive non-birefringent prism of a molecular fluorine laser system according to another preferred embodiment.

FIG. 7b schematically illustrates an alternative configuration of the resonator of FIG. 7a.

FIG. 8a schematically illustrates a resonator including a wavefront compensation lens, a dispersive, Brewster birefringent prism and a dispersive non-birefringent Brewster prism of a molecular fluorine laser system according to another preferred embodiment.

FIG. 8b schematically illustrates an alternative configuration of the resonator of FIG. 8a.

FIG. 9a schematically illustrates a resonator including a wavefront compensation lens, two dispersive, non-birefringent Brewster prisms and a dispersive birefringent half-prism of a molecular fluorine laser system according to another preferred embodiment.

FIG. 9b schematically illustrates an alternative configuration of the resonator of FIG. 9a.

FIG. 10 schematically illustrates a molecular fluorine laser system according to a preferred embodiment.

### INCORPORATION BY REFERENCE

What follows is a cite list of references each of which is, in addition to those references cited above and below, and including that which is described as background and the summary of the invention, hereby incorporated by reference into the detailed description of the preferred embodiments below, as disclosing alternative embodiments of elements or features of the preferred embodiments not otherwise set forth in detail below. A single one or a combination of two or more of these references may be consulted to obtain a variation of the preferred embodiments described in the detailed description below. Further patent, patent application and non-patent references are cited in the written description and are also incorporated by reference into the detailed description of the preferred embodiment with the same effect as just described with respect to the following references:

Published PCT application no. WO 00/38281;

U.S. patent application Ser. Nos. 09/317,695, 09/598,552, 09/594,892, 09/131,580 and No. 60/140,530, Ser. No. 09/574,921, Nos. 60/166,277, 60/200,163, 60/212,257, 60/215,933, 60/212,301, Ser. Nos. 09/883,097, 09/482,698, 09/512,417, 09/599,130, 09/598,552, 09/712,877, 09/738,849, 09/715,803, No. 60/280,398, Ser. Nos. 09/718,809, 09/771,013, 09/780,124, 09/584,420, 09/883,127, 09/883,128, 09/923,770, Nos. 60/244,744, 60/243,462, 60/296,898, 60/309,939, which are assigned to the same assignee as the present application;

U.S. Pat. Nos. 6,285,701, 6,154,470, 6,157,662, 6,219,368, 6,005,880, 5,559,584, 5,221,823, 5,763,855, 5,811,753, 6,061,382, 5,946,337, 6,020,723, 5,095,492, 6,094,448, 6,018,537, 5,898,725, 6,018,537, 5,761,243 and 4,616,908;

Marilyn J. Dodge, “Refractive Properties of Magnesium Fluoride,” Applied Optics, vol. 23, no. 12, 1984, pp. 1980-1985;

U. Stamm, “Status of 157 nm The 157 Excimer Laser,” International SEMATECH 157 nm Workshop, Feb. 15-17 1999, Litchfield, Ariz., USA;

T. Hofman, J. M. Hueber, P. Das, S. Scholler, “Prospects of High Repetition Rate F₂ (157 nm) Laser for Microlithography”, International SEMATECH 157 Workshop, Feb. 15-17 1999, Litchfield, Ariz., USA;

U. Stamm, I. Bragin, S. Govorkov, J. Kleinschmidt, R. Patzel, E. Slobodtchikov, K. Vogler, F. Voss, and D. Basting, “Excimer Laser for 157 nm Lithography”, 24th International Symposium on Microlithography, Mar. 14-19,1999, Santa Clara, Calif., USA;

T. Hofmann, J. M. Hueber, P. Das, S. Scholler, “Revisiting The F₂ Laser For DUV microlithography”, 24th International Symposium on Microlithography, Mar. 14-19, 1999, Santa Clara, Calif., USA;

W. Muckenheim, B. Ruckle, “Excimer Laser with Narrow Linewidth and Large Internal Beam Divergence”, J. Phys. E: Sci. Instrum. 20 (1987) 1394;

G. Grunefeld, H. Schluter, P. Andersen, E. W. Rothe, “Operation of KrF and ArF Tunable Excimer Lasers Without Cassegrain Optics”, Applied Physics B 62(1996)241; and

W. Mueckenheim, “Seven Ways to Combine Two Excimer Lasers,” reprinted from July 1987 edition of Laser Focus/Electro-Optics.

### DETAILED DESCRIPTION OF THE PREFERRED EMBODIMENTS

The preferred embodiments described below set forth advantageous molecular fluorine (F₂) laser system configurations, particularly for microlithography, with optimized output parameters including high output power, high degree of polarization and high spectral purity. When the term “laser system” is referred to herein, including in the claims, it is meant to include any recited extra-cavity optical components, e.g., an extra-cavity polarizer in addition to that which is contained within the laser resonator and associated electronics, processing and/or gas handling equipment, etc. In general with respect to the preferred embodiments, the efficiency of the F₂-laser resonator may be increased by reducing the optical path length and/or number of optical components in the beam path, e.g., by providing optical components that perform multiple functions. Line selection may be achieved by using a wavelength-dispersive prism in combination with a lens that corrects the divergency of the beam inside the resonator. Line-selection may be performed by other means alternative or in addition to the dispersive prism such as an interferometric device such as an etalon, a grating, a grism and/or a birefringent or interferometric plate (see U.S. patent applications Ser. Nos. 09/317,695, 09/599,130, 09/738,849, 09/715,803, 60/280,398, 09/718,809, 09/883,127, 09/883,128, 09/923,770, which are assigned to the same assignee as the present application and are hereby incorporated by reference). Narrowing of the selected line may also be performed using a prism, an interferometric device, a grating, a grism, etc. (see U.S. Pat. No. 6,154,470, which is hereby incorporated by reference, as well as the patent applications cited above).

Polarization of the beam may be achieved preferably using one of four techniques, or a combination of any two or more of these techniques. A first preferred technique utilizes a birefringent prism, in which the refraction angle is dependent on the polarization of the beam, wherein a first polarization component is refracted within the acceptance angle of the resonator and a second polarization component is refracted outside the acceptance angle of the resonator. A second method involves providing one or preferably several optical components inside the resonator having one or more optical surfaces at Brewster's angle to the beam (e.g., one or more Brewster plates, Brewster prisms, Brewster windows and/or aligning a wavefront compensation lens with a surface oriented substantially at Brewster' angle). Each such Brewster surface has a reflectivity of roughly 10% for the s-polarization component of the beam, while transmission for the p-polarization component of the beam is theoretically 100% (neglecting surface and bulk losses). However, each optical component adds to the overall loss of the beam energy due to scattering on the surfaces and in the bulk, due to imperfections of structure and contaminants. Consequently, the preferred design achieves an advantageous compromise between the number of optical elements that provide spectral and polarization discrimination, and, on the other hand, minimal optical path length and number of optical surfaces.

A third method uses a birefringent prism, albeit of a different kind. Here, the prism is designed in such a way that there is at least one total internal reflection (TIR) inside the prism. Since the critical angle of TIR depends on the refractive index, it is possible to arrange that the extraordinary ray (e-ray) be completely reflected inside the prism and returned or reflected within the acceptance angle of the resonator, and that the ordinary ray (o-ray) be only partially reflected and/or reflected outside the acceptance angle of the resonator. Thus, the o-ray suffers substantial loss and is not or is substantially not resonated, resulting in the output beam becoming substantially polarized.

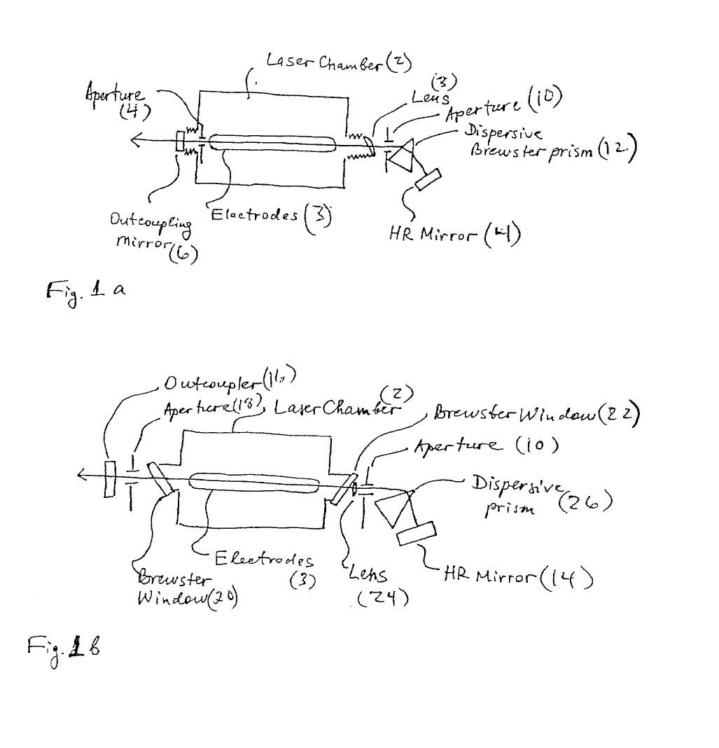

Finally, the fourth method uses a polarizing component placed at the output of the laser, i.e., extra-cavity, in order to reject the portion of the beam having the unwanted polarization. The laser can be one of the first three embodiments, but with relaxed specifications on degree of polarization. Examples of such polarizing components are a Rochon prism made of MgF₂, or a proprietary polarizing prism based on TIR, as will be described in more detail below, or fewer than the preferred three intra-cavity Brewster plates according to an embodiment described below, or generally fewer intracavity Brewster surfaces, e.g., plates, windows, prisms and/or surface or wavefront compensation lens, than may be otherwise used to get a 157 nm output beam having a polarization of 95% or better, or more preferably 98% or better. The degree of intra-cavity polarization may be relaxed due to the polarization-enhancing feature of the extra-cavity polarizer used in this embodiment. In the preferred embodiments schematically illustrated at FIGS. 1a-4b and 6a-7b, a dispersive Brewster prism is included as a component for providing angular wavelength dispersion for selecting a primary line λ₁ among multiple characteristic emission lines around 157 nm of the F₂ laser including suppressing a secondary line λ₂ of the multiple lines by refracting or reflecting (on not reflecting) the secondary line, and in each case at least a significant portion of the secondary line is directed outside the acceptance angle of the resonator so that the secondary line is suppressed in the output beam. Other optics may be used for line-selection in addition or alternative to the preferred dispersion prism, such as a grating, a grism, an interferometric device such as an etalon or a device having non-parallel plates such as is described at the Ser. No. 09/715,803 and No. 60/280,398 applications, incorporated by reference above, a birefringent plate or block and/or an interferometric block, plate or structure and/or including one or more apertures and/or using a reduced gas mixture pressure, or otherwise as described in the references incorporated by reference herein or as understood by those skilled in the art. In addition, the wavelength selection optic may be disposed on the fronts optics side of the laser tube, and may serve to outcouple the laser beam or be disposed between an output coupler and the discharge tube, wherein other optics may be differently disposed in the resonator in this approach such as a preferred wavefront compensating optic, an optional beam expander, etc.

In the preferred approach, the dispersion prism is placed in the optical beam path so that the beam is incident onto each surface at approximately Brewster's angle, and as such, the preferred dispersion prism is referred to herein as a Brewster prism, although a prism having only one surface aligned at Brewster's angle to the beam may advantageously be used to increase the polarization of the beam, and so when the term “Brewster prism” is used herein including in the claims, it is meant to include a prism having at least one surface, and preferably two surfaces, aligned at Brewster's angle to the beam.

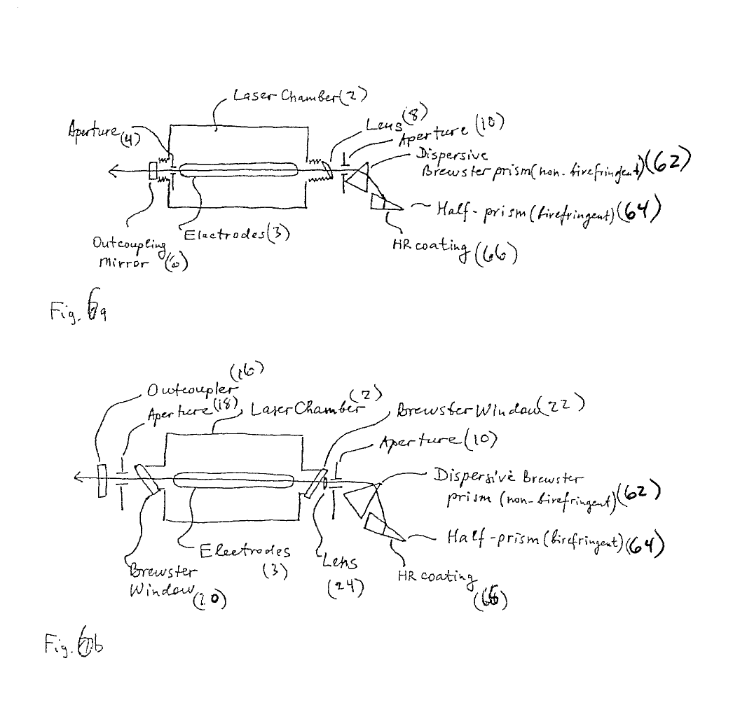

Due to the wavelength dispersion of the refractive index, the refraction angle is slightly different for the different wavelengths, and particularly the wavelengths of the primary and secondary characteristic emission lines of the F₂ laser around λ₁ =157.629 nm and λ₂=157.523 nm, respectively (see the U.S. Pat. No. 6,154,470 patent, e.g., at FIG. 6a therein). By adjusting a highly reflective (HR) resonator reflector mirror so as to return the beam with desired wavelength back into the resonator, substantially only the spectral component of desired wavelength is resonant over multiple round-trips inside the resonator. The fundamental limitation of this approach is set by the angular resolution Df of the resonator, as related to the magnitude of angular dispersion of the prism df/dl. The second spectral line will be completely suppressed if the following condition is met:

Df<(df/dl)·Dl, (1)

where Dl is the spectral separation of the two spectral lines (approximately 106 pm). The angular resolution of the resonator Df is defined by the divergency of the beam inside the resonator. Therefore, a lower divergency may be beneficial because it allows reduced requirements to the magnitude of spectral dispersion. This, in turn, allows a reduction of the number of dispersive components for achieving the desired line-selection, and therefore, reduces a number of optical surfaces and optical path length inside the resonator.

It is recognized herein that there are two main contributions to the divergency of an excimer or molecular fluorine laser beam. The first one is caused by low spatial coherence (or, in other terms, multi-spatial mode content) of the beam, so that the spatial coherence radius is substantially less than the beam diameter. This leads to increased diffraction, as compared to a single spatial mode beam.

The second component is caused by the deviation of the beam wavefront from planarity. Our measurements yielded a wavefront curvature with an approximate radius of 2.5 m at the end of the laser chamber. The wavefront curvature is advantageously corrected using an appropriate lens according to a preferred embodiment (see also U.S. Pat. No. 6,061,382, which is assigned to the same assignee as the present application and is hereby incorporated by reference), and may be otherwise corrected using a non-dispersive deformed or deformable mirror (see U.S. Pat. No. 6,298,080) or plate or deformable lens (see U.S. patent application No. 60/235,116, which is assigned to the same assignee as the present application and is hereby incorporated by reference), or a curved grating (see U.S. Pat. Nos. 6,094,448 and 5,095,492, which are hereby incorporated by reference).

Among some other advantages of the preferred embodiments generally, the number of optical interfaces with the beam may be reduced by using an optical component to perform multiple functions. For example, a window on the discharge chamber that may be used to seal the discharge chamber of the laser system, may also serve to output couple the laser beam and/or correct the wavefront curvature of the beam and/or participate in the preferred polarizing the beam and/or perform wavelength selection and/or serve as a highly reflective resonator reflector. A wavelength selection optic may serve also to participate in the preferred polarizing of the beam, e.g., by having Brewster surfaces and/or by being birefringent, and/or as an outcoupling or highly-reflective resonator reflector. A wavefront compensation optic may also serve to participate in the preferred polarizing of the beam, e.g., by having a Brewster surface, and/or as an outcoupling or highly-reflective resonator reflector and/or to separate modules maintained at different pressures of a line-selection package (see the No. 60/235,116 application mentioned above). One or more apertures may be used to define the acceptance angle of the resonator and providing a feature of facilitating lineselection.

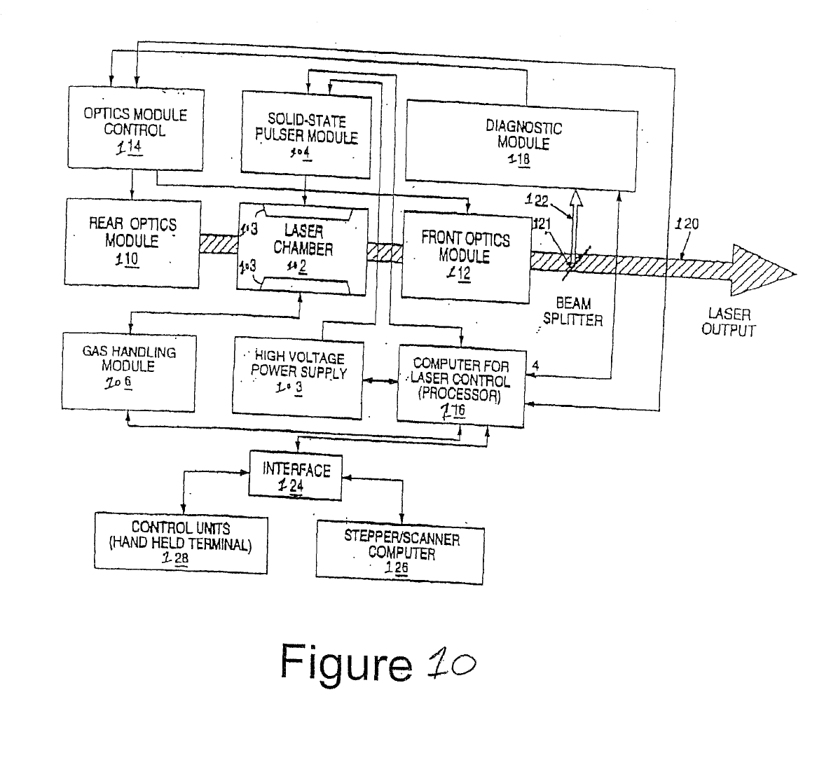

FIG. 1a schematically illustrates a first resonator configuration, among several exemplary configurations shown and described herein, according to a preferred embodiment. The resonator configuration shown at FIG. 1a includes a laser chamber 2 including multiple electrodes connected to a discharge circuit (not shown, but see below with reference to FIG. 10), and including one or more preionization electrodes (also not shown, but see U.S. patent applications Ser. Nos. 09/247,887, 09/532,276 and 09/692,265, which are assigned to the same assignee as the present application and are hereby incorporated by reference, and see below with reference to FIG. 10, and also see FIG. 10 and accompanying description for other general features of the laser chamber 2 as well as the preferred overall laser system that will not be continuously repeated elsewhere herein with reference to the embodiments shown and described at FIGS. 1a-9b) and a pair of main discharge electrodes 3 spaced apart by a discharge region filled with a gas mixture at least including molecular fluorine and a buffer gas such as helium and/or neon. An aperture 4 is shown optionally disposed within the laser chamber 2, although the aperture 4 may be disposed outside the chamber 2 particularly in embodiments wherein the output coupler 6 is not also used to seal the laser chamber 2 as in the embodiment shown at FIG. 1a.

A lens 8 is shown sealing the laser chamber 2 on the other end from the output coupler 6. The lens 8 has a first surface facing the discharge region between the electrodes 3 that is oriented substantially at Brewster's angle to the incident beam. This first surface or Brewster surface of the lens 8 may be substantially planar. The lens 8 has a second surface facing away from the laser chamber 2 that is configured to correct or compensation the wavefront curvature of the beam. A second aperture 10 is shown disposed after the lens 8 in FIG. 1a.

After the aperture 10 is disposed a dispersive prism 12 which is preferably also a Brewster prism with one or preferably both surfaces oriented at Brewster's angle to the beam that strikes the prism 12. The prism 12 is formed of a material that is substantially transparent for wavelengths around 157 nm, such as preferably MgF₂ when it is desired to take advantage of the birefringent properties of magnesium fluoride, or preferably CaF₂ when effects due to the birefringent nature of MgF₂ are not desired, or alternatively such materials as LiF, BaF₂, SrF₂ or others known to those skilled in the art such as potassium-doped CaF₂ (see U.S. published U.S. patent application No. 20/010,019,453, which is hereby incorporated by reference), or fluorine-doped quartz, etc.

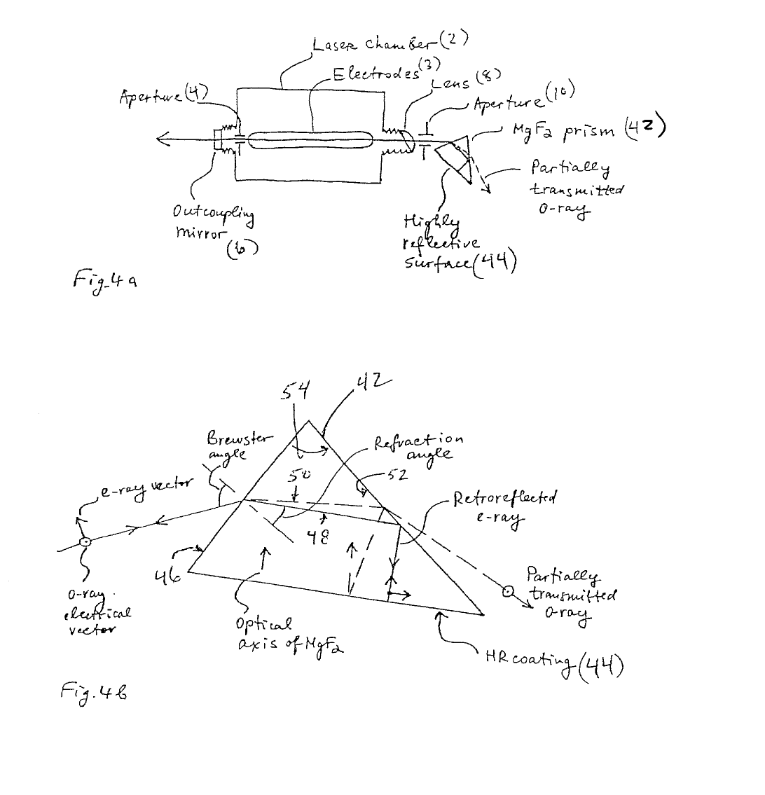

The dispersive prism 12 serves to refract the primary line λ₁ around 157.629 nm to remain within the acceptance angle of the resonator, which is preferably at least in part defined by the apertures 4, 10, and to refract the secondary line λ₂, and possibly other lines (see the No. 60/309,939 application, mentioned above), outside the acceptance angle of the resonator, such that the primary line is selected and/or the secondary line is suppressed, among the multiple characteristic emission lines of the F₂ laser around 157 nm. When the dispersion prism 12 is also a Brewster prism, the prism 12 also serves to facilitate the preferred polarizing of the selected primary line of the output beam. An HR mirror 14 is shown disposed after the prism 12 as a resonator reflector, which may be excluded if the prism 12 has a highly reflective coating formed on its back surface as a resonator reflector surface (see FIGS. 4a-4b, 6a-7b and 9a-9b, and corresponding description below).

The resonator arrangement schematically shown at FIG. 1b is similar to that of FIG. 1a in many respects that will not be repeated here. The output coupler 6 and aperture 4 of FIG. 1a are replaced by output coupler 16, aperture 18 and Brewster window 20 in FIG. 1b. The output coupler 16 no longer seals the chamber 2 as the outcoupler 6 of FIG. 1a does, and the aperture 18 is outside the chamber 2, unlike the aperture 4 that is inside the chamber 2 in FIG. 1a. The Brewster window 20 seals the chamber and serves to facilitate the preferred polarizing of the beam.

The other end of the chamber is sealed by another Brewster window 22 and the lens 24 does not seal the chamber 2 as the lens 8 of FIG. 1a does. The lens may have the surface that faces the discharge chamber 2 oriented at Brewster's angle or this surface may be normal to the beam with or without an antireflection coating formed on either surface. The aperture 10 is disposed after the lens 24 and a dispersive prism 26 is disposed between the aperture 10 and an HR mirror 14. The effect of the Brewster windows 20 and 22 on the polarization of the beam is greater than that of the outcoupler 6 and lens 8 of the arrangement of FIG. 1a. The dispersive prism 26 may be a Brewster prism as is preferred for the prism 12 of FIG. 1a, or the prism 26 may have its surfaces not aligned at Brewster's angle, while the polarization may still be sufficient.

The embodiments shown and described with reference to FIGS. 1a and 1b include optical components that perform multiple functions in the resonator and so include a smaller number of optical components than an arrangement that does not, while still achieving the desired line-selection, polarization and wavefront compensation. In experiments, the lens 8 or 24 has a focal length of 2.5 m and achieved reduction of the intensity of second spectral line to below 0.5% of the total output. The lens can be tilted at approximately Brewster angle to the beam, so as to reduce reflective losses and improve polarization of the laser beam. Alternatively, the lens can be disposed nearly normally to the beam and optionally coated with anti-reflective thin-film coating.

As mentioned, it is desired to polarize the beam to at least 95% polarization and even 97.5% polarization or more. For certain applications, such as microlithography utilizing catadioptric projection lenses with polarizing beamsplitters, it is desired to have an exposure beam with at least 97.5% polarization. As also briefly averred to above, the degree of polarization of the beam is preferably controlled according to embodiments described herein by at least four alternative methods, or any combinations thereof, i.e., utilizing a birefringent dispersive prism, inserting piano-parallel laser chamber windows at the Brewster angle, and Brewster prisms, into the beam path, using a birefringent prism with a total internal reflection, and/or using an external polarizing component placed at the output of the laser.

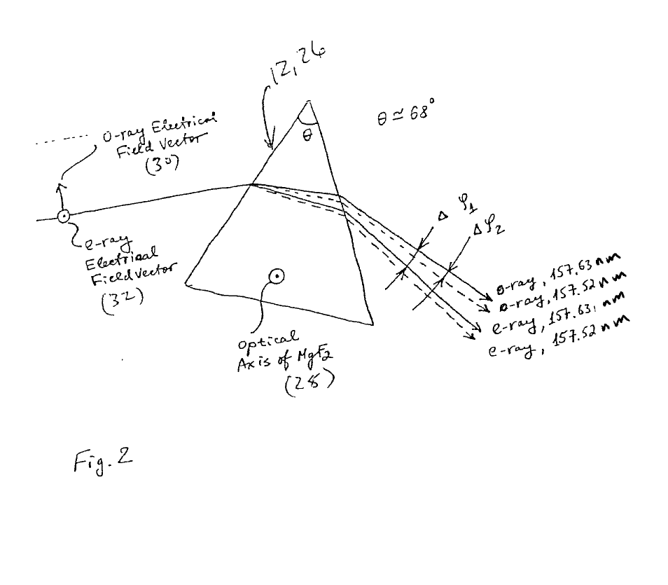

FIG. 2 schematically illustrates the idea behind the use of a birefringent prism for polarization selection. In this configuration, the dispersive prism is made of birefringent material transparent in the DUVNUV range, such as preferably magnesium fluoride (MgF₂). The optical axis 28 of the material is oriented orthogonally to the plane of the drawing (FIG. 2). Therefore, the beam with in-plane polarization is the ordinary ray (or o-ray) 30, and the beam with out-of-plane polarization is the extra-ordinary ray (or e-ray) 32. The difference in refractive indexes for the e-ray 32 and the o-ray 30 is approximately (nₑ−nₒ)=0.014. This means that the refraction angle of the e-ray 32 is larger than that for o-ray 30. The difference is Δφ₁=0.75°. Therefore, upon a round-trip through the dispersion prism 12, 26, the o-ray 30 is separated by 2Δφ₁=1.5° from the e-ray 32. This is more than sufficient to suppress the undesired beam (or the e-ray 32, in this case). Only the beam with in-plane polarization, i.e., the o-ray 30, is substantially therefore oscillated.

In addition, due to spectral dispersion of the magnesium fluoride, the beam of each polarization will also split into two beams according to the different wavelengths of the primary and secondary lines, i.e., around 157.523 nm and 157.629 nm as shown in FIG. 2. The angle between these two beams is approximately Δφ₂=0.1°. Thus, the highly reflective mirror can be aligned in such way that only o-ray component with wavelength of 157.629 nm will be substantially oscillated, resulting in line-selected and in-plane polarized output. The o-ray 30 in this case is also the beam which suffers minimum losses at the Brewster surfaces of the prism 12, 26, when the prism 12, 26 is configured and oriented as a Brewster prism. This provides some additional discrimination of the out-of-plane polarized beam.

Another variation of this embodiment is to configure and/or orient the prism 12, 26 such that the optical axis 28 of the material of the prism 12, 26 is in-plane of the drawing. In this case, the basic idea remains the same, except that the in-plane polarized beam is the e-ray, and the refraction angles are different.

The choice of material for the prism 12, 26 when it is desired that the prism 12, 26 be birefringent is limited by the number of materials that are substantially transparent around 157 nm and that are also significantly birefringent. Therefore, MgF₂ is the most preferred candidate, while other available substantially VUV transparent materials such as CaF₂, BaF₂, and LiF are substantially not birefringent.

Another possible configuration exploiting the same idea is to swap the HR mirror 14 and the outcoupler 6, 16. An advantage of this alternative embodiment is that the beam traverses the prism 12, 26 just prior to being output. This will cause the out-of-plane polarized portion of the amplified spontaneous emission (ASE) to be angularly separated from the in-plane polarized beam. However, in the previous configuration, only half of the final round-trip contributes to the ASE. Therefore, the choice of either embodiment is dependent on the concrete laser parameters, such as overall gain, and may be generally determined experimentally.

Another possible embodiment may include Brewster windows 20, 22 to seal the tube 2, as shown in FIG. 1b. An advantage here is that the laser chamber 2 can be mechanically de-coupled from the optical resonator, thus improving the stability of the laser output. However, the cavity length and number of optical surfaces may increase, thus reducing the efficiency of the laser, and a balancing may again be performed between these considerations.

The wavefront-correcting lens 8 of the arrangement of FIG. 1a is shown oriented at Brewster's angle to the beam (and the lens 24 may also be oriented at Brewster's angle). An advantage of this arrangement is that optical reflection losses are reduced. However, in case the lens 8, 24 is a spherical lens, there may be a substantial beam aberration due to astigmatism of the lens. A first solution to this may include using the lens at nearly normal incidence, with an anti-reflective coating (on the side not exposed to the laser gas for the lens 8). A second solution to this may include using a cylindrical lens at Brewster's angle, with the curvature being in plane of the drawings of FIG. 1a and 1b. With respect to this second solution, the wavelength- and polarization-dispersion occur in the plane of drawing, and therefore, any wavefront curvature correction perpendicular to the plane of the drawing is not as significant.

As mentioned in more detail below with reference to FIG. 10, the beam path outside the laser chamber 2, both intra-cavity and extra-cavity, is purged with inert gas, or alternatively evacuated, or segments of the beam path may be purged with inert gas while other segments are evacuated, wherein high purity nitrogen or a noble gas may be preferably used, in order to avoid beam absorption by contaminants such as hydrocarbons, water and oxygen (see, e.g., U.S. Pat No. 6,219,368 and U.S. patent application Ser. Nos. 09/317,695, 09/594,892, 09/598,552, 09/712,877 and No. 60/281,433, which are assigned to the same assignee as the present application and are hereby incorporated by reference).

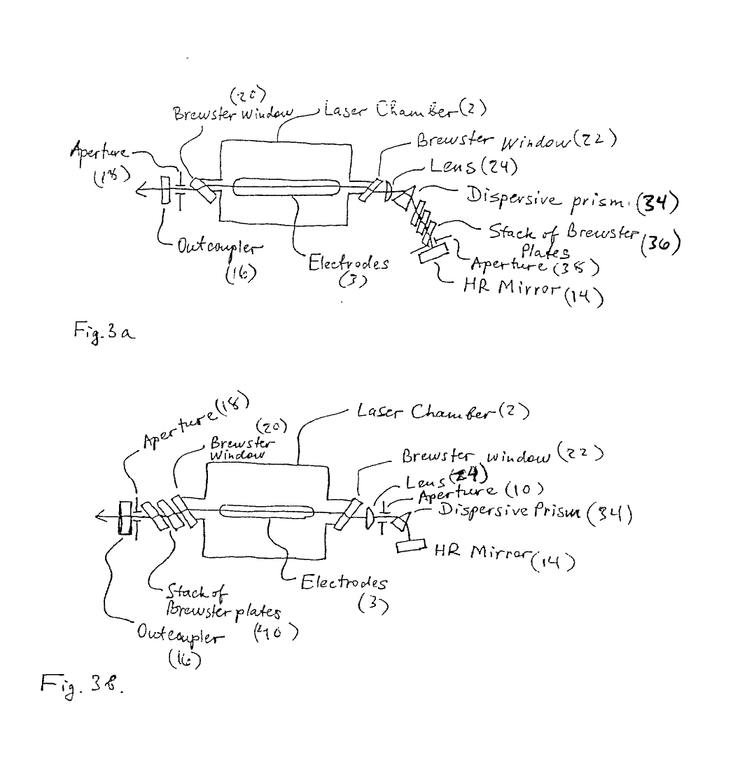

According to a second group of embodiments schematically shown at FIGS. 3a and 3b, wavelength selection is preferably provided by using a dispersive prism, such as that described above with reference to FIGS. 1a and 1b, and which also preferably includes one, or more preferably two, Brewster surfaces. Same or similar components of FIGS. 3a and 3b are designated with the same reference numerals as in FIGS. 1a and 1b and their description is not repeated here, although any of these components may be modified to optimize the system, e.g., the outcoupler 16 may have a higher or otherwise different reflectivity such as to balance the losses incurred by the additional optical surfaces and increased resonator length provided by the inclusion of the Brewster plates 36 (see below) and/or the aperture 18 (or aperture 38 compared with aperture 10) may be adjusted to adjust the acceptance angle of the resonator, e.g., due to the different dispersivity of the CaF₂ material forming the dispersion prism 34 that is preferred in this embodiment compared with the preferred MgF₂ material used in the embodiments of FIGS. 1a and 1b, etc.

In contrast to the resonator configurations shown and described with reference to FIGS. 1a and 1b, polarization in the embodiments of FIGS. 3a and 3b is provided by means of at least one and preferably multiple, e.g., two or three or more, Brewster angle plates 36 inside the optical resonator. In a particularly preferred embodiment, three Brewster plates 36 are used as striking a balance between obtaining the desired polarization, e.g., more than 95% or more than 97.5%, and the Brewster plates 36 becoming too lossy within, and/or extending the length of, the resonator, i.e., a disadvantage of this approach is that the inclusion of multiple Brewster plates 36 provides multiple additional optical surfaces in the beam path, and the optical path length in resonator would typically become longer. Also, the extinction ratio of the Brewster plates may be quite low. However, as the polarization is provided in these embodiment by the plates 36, it is less advantageous to also have a birefringent prism, so the dispersion prism 34 is preferably formed of high quality calcium fluoride (CaF₂), which presently can be manufactured with higher optical quality and lifetime than MgF₂.

The Brewster plates 36 are shown disposed between the dispersive prism 34 and the HR mirror 14 in FIG. 3a. The aperture 38 is also shown disposed between the Brewster stack of plates 36 and the HR mirror 14 in FIG. 3a. The Brewster plates 40 are disposed between the laser chamber 2 and the output coupler 16 in FIG. 3b, and the aperture 18 is disposed between the outcoupler 16 and the Brewster stack 40, while the aperture 10 is this time disposed between the lens 24 and the dispersive prism 34.

Similarly to the first group of embodiments schematically shown at FIGS. 1a and 1b, the lens 24 (which may also be used to seal the discharge chamber 2, just as lens 8 of FIG. 1a, in either of embodiments of FIGS. 3a or 3b, and just as the outcoupler 16 of FIG. 3a can be used to seal the chamber 2 as the outcoupler 6 in the embodiment of FIG. 1a, wherein the aperture 18 may be disposed within the chamber 2 as the aperture 4 of FIG. 1a) is used to correct the wavefront curvature. Brewster windows 20 and 22 are preferably used to seal the discharge chamber 2 and thus, mechanically de-couple resonator optics from the chamber 2. From practical experience, it is desired to insert additional Brewster plates 36, 40 into the beam path (in addition to the tube windows 20, 22), in order to achieve a degree of polarization in excess of 95%, or 97.5%, or otherwise depending on the application specifications.

The embodiments shown in FIGS. 3a and 3b differ in that the Brewster plate stack 36 is located close to the highly reflective mirror 14, while the Brewster stack 40 is located close to the outcoupler 16. Alternatively, one or more to several plates can be inserted on both sides of the chamber 2 (not shown in FIGS. 3a or 3b). Additionally, more alternative configurations can be created by swapping HR mirror 14 and the outcoupler 16, e.g, such that the dispersion prism 34 is located on the outcoupling side of the resonator, and in this case along with the lens 24. As averred to above, FIGS. 3a and 3b show three and two Brewster plates 36 and 40, respectively, besides the tube windows 20 and 22, while the exact number may be adjusted as dictated by concrete user requirements of degree of polarization and efficiency of the laser.

Instead of inserting additional Brewster plates, one can use additional prisms with Brewster surfaces. Generally, using Brewster windows 20, 22 provides a shorter optical path length inside the resonator than inserting additional optics, as well as a shorter path inside the optical material. Therefore, if sufficient spectral discrimination can be provided (i.e., depending on the application specs) by means of a single prism, the preferred method is to insert one or more Brewster windows 20, 22 into the optical beam path. The Brewster windows 20, 22 also advantageously serve the additional function of sealing the laser tube 2.

Referring now to FIGS. 4a and 4b, another embodiment includes a birefringent and wavelength-dispersive prism 42 including a highly reflective (HR) coating 44 on one side, as shown. An advantage of this embodiment is that it includes a reduced number of optical components and a minimal optical path length inside the resonator, while providing the desired high degree of polarization selectivity. FIG. 4a shows the general layout of the resonator and can be altered according to any of the other embodiments described elsewhere herein, and the general description of features already introduced and described is not repeated in large detail here. The lens 8 (which may be replaced by a window 22 and lens 24) is used to correct the wavefront curvature, and may be preferably disposed either at nearly Brewster's angle to the beam, or at nearly normal incidence, wherein the lens may or may not have an anti-reflection coating formed thereon. The lens 8 may be either spherical or cylindrical.

FIG. 4b illustrates some details of optical beam path inside the prism 42. The beam is incident onto the first surface 46 of prism preferably at approximately Brewster's angle. Refraction at the first surface results in a small angular separation of the beams with two different wavelengths (i.e., 157.523 nm and 157.629 nm) which is not shown in the drawing. This angular separation provides spectral line selection, similarly to other embodiments. Upon entering the prism, the in-plane polarized component of the beam becomes the e-ray 48, and out-of-plane component of the beam becomes the o-ray 50, due to the orientation of the optical axis of the prism 42 and the birefringent nature of the MgF₂ material that the prism 42 is made of. The refraction angle at the first surface 46 for the e-ray 48 is smaller than that for o-ray 50, as shown. Therefore, the two beams are incident onto the second (internal) reflecting surface 52 at different angles (the o-ray 50 having a smaller angle) and at different positions. In addition to that, the total internal reflection (TIR) critical angle for the e-ray 48 is smaller than that of the o-ray 50. Thus, the apex angle 54 of the prism 42 is preferably selected in such a way, that the incidence angle of the e-ray 48 onto the second surface 52 is larger than the critical TIR angle, and the incidence angle of the o-ray 50 is smaller than critical TIR angle for the o-ray 50. This leads to total reflection of the e-ray 48, and partial transmission of o-ray 50. After reflection from the second surface 52, the e-ray 48 is retro-reflected by the highly reflective coating 44 formed at a third reflective surface of the prism 42 and is returned within the acceptance angle of the resonator, which is preferably defined at least in part by one or more apertures 4, 10 (or 18 or 38, see FIG. 3a). At the same time, the o-ray 50 is reflected at a different angle and at a different position than the e-ray 48 and is at least substantially not resonated.

Based on refractive index data for MgF₂ (see, e.g., Marilyn J. Dodge, “Refractive Properties of Magnesium Fluoride,” Applied Optics, vol. 23, no. 12, 1984, pp. 1980-1985), the transmittance of the o-ray 50 at the second surface 52 is approximately 42%, given an apex angle 54 of 76.8°. Therefore, there are at least two preferred mechanisms (and other mechanisms described herein may be combined with these) that lead to selection of the in-plane polarization component 48 of the beam in the resonator. First, there is an angular separation of the two orthogonally polarized components 48 and 50 of the beam that occurs upon the components' making a round-trip through the prism 42. Second, significant losses occur for the out-of-plane polarized component 50 of the beam at the second reflecting surface 52. Therefore, an advantage of this embodiment is that it provides a high degree of polarization selectivity with a small number of optical surfaces exposed to the outside environment. This leads to a reduced amount of optical losses, and an enhanced lifetime of optical components. However, the spectral line selectivity that is provided by the embodiment specifically shown at FIG. 4a depends only on the single Brewster surface 46, and therefore, less selectivity is provided than in other embodiments, while additional line-selectivity may be provided in the embodiment of FIG. 4a by adding one or more line-selection optics such as those otherwise mentioned herein.

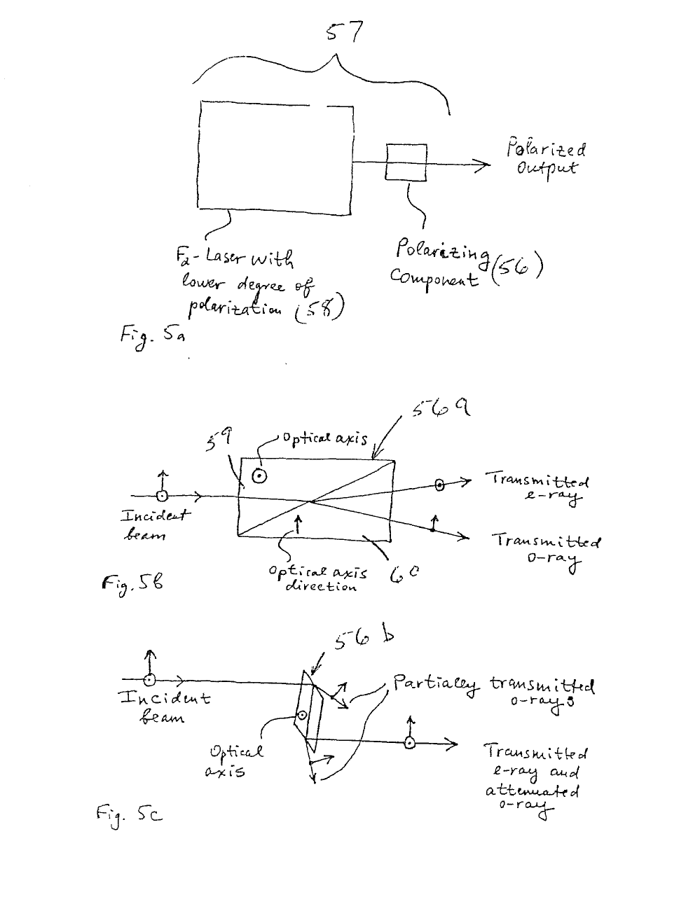

Another group of embodiments uses an external or extra-cavity polarizing component 56 (see FIGS. 5a-5c) to create a highly polarized output beam, such that the laser cavity may itself provide a somewhat lower degree of polarization as compared to the embodiments set forth above, while the laser system including the extra-cavity polarizer 56 still provides the desired degree of polarization, e.g., 95% or 97.5% or more. The advantage of doing so is that one may have fewer components inside the laser resonator, which may lead to higher efficiency and output power of the laser. This increase in output power may be more than sufficient to compensate for the loss of the out-of-plane polarized component 50 (see FIG. 4b) of the beam due to the effects of the external polarizing component 56. A somewhat simplified laser resonator may also be used which may generally lead to a higher pulse-to-pulse energy stability. A potential disadvantage is that the intensity of the beam may be higher within optical components of resonator, thus leading to shorter lifetime, to balance the attenuation that will occur when the beam traverses the extra-cavity polarizer 56.

Another consideration is the transmittance, contrast and lifetime of the polarizing component 56. Possible examples of such polarizing component 56 include a stack of Brewster-angle plates, a thin-film polarizer (TFP), a polarizing prism, such as a Glan-Thompson prism, a Glan-Taylor prism, a Wollaston prism or a Rochon prism, or proprietary prism with TIR as described above with reference to FIGS. 4a-4b.

FIG. 5a schematically shows a general layout of the laser system 57 according to this embodiment includes an F₂-laser 58 that may provide a lower degree of polarization that is desired for the output beam, which is coupled with an extra-cavity polarizer 56 that raises the degree of polarization to the desired level. Preferably, the output of the laser resonator 58 is at least partially polarized. The degree of polarization of the output of the overall system 57, or Stotal, is related to the polarization of the laser 58, or slaser, and the extinction ratio C of the polarizing component through this formula:

Sₜₒₜₐₗ=1−(1−Sₗₐₛₑᵣ)/C (2)

where the extinction ratio C of the polarizing component 56 is defined as the ratio of transmittance for the in-plane to the out-of-plane polarized beams through the polarizer 56. For example, a Brewster-angle plate may typically have a transmittance of roughly 90% and 100% (neglecting losses) for s- and p-polarized beams, respectively. Therefore, the extinction ratio C of a single Brewster-angle plate will be 1.11, whereas the extinction ratio of n-plates will be 1.11·n (again, neglecting losses), and therefore, theoretically, three Brewster plates placed at the output of the laser 58 with polarization degree sₗₐₛₑᵣ=93% will result in the output polarization of the system sₜₒₜₐₗ=95%. However, the polarizing component 56 rejects at least the amount of the output energy that is contained in the out-of-plane polarized beam 50 (see FIG. 4b), or more depending on losses in polarizing component 56. Therefore, in order to provide a specified output power at the output of the polarizer 56, a preferred partially polarized laser 58 is configured to have excess power, as compared to a laser having highly polarized output.

A disadvantage of the approach with the stack of Brewster plates is that the extinction ratio C of such polarizer 56 is quite low. Thin-film polarizers can provide extinction ratios C on the order of 100 in a single component. Therefore, such system 57 including a polarizer 56 including a low-loss thin-film with a high extinction ratio C and a high laser damage threshold suitable for 157 nm is advantageous.

FIG. 5b schematically shows an example of a polarizing prism 56a, similar in concept to a Rochon prism. The prism 56a includes two portions 59 and 60 made of a birefringent material, such as MgF₂, optically coupled and preferably in physical contact with each other. Optical axes of the two halves are orthogonal to each other, as illustrated, so that the incident beam suffers refraction when going from the optically denser to the optically less dense medium, or vice versa, depending on the beam polarization. Therefore, the refraction angle at the boundary is different for the two orthogonal polarizations. Thus, the beams with two orthogonal polarizations are angularly separated, and the undesired beam can be blocked by a suitable beam block. Other possible configurations of the polarizing prism 56a may be based on a similar concept. For example, the prism 56a may have its optical axis of the second half 60 in the plane of the drawing and parallel to the beam direction. The extinction ratio C of a prism 56a based on this concept can be extremely high, e.g., exceeding 1000.

FIG. 5c schematically illustrates another embodiment of an extra-cavity polarizer 56, which is in this case a polarizing prism with total internal reflection (TIR), or a TIR polarizing prism 56b. The optical axis of the prism made of MgF₂ is oriented orthogonally to the plane of the drawing. Therefore, the incident beam with in-plane polarization becomes the o-ray, while the beam with out-of-plane polarization is the e-ray. Since the refractive index n is different for these two beams, the critical angle f_{c} is different also:

f_{c}=arcsin (1/n) (3)

and using the index data referred to above from Stamm et al., the difference in the critical angles f_{ce} and f_{co} for e-ray and o-ray, respectively, is approximately 0.5 degrees at 157 nm in MgF₂. Therefore, if the beam incidence angle is larger than f_{ce} but smaller than f_{co}, then the e-ray will be completely reflected, and the o-ray will be partially transmitted. For an exemplary incidence angle set right in the middle between the two critical angles, transmission of the o-ray equals about 54%. This results in an extinction ratio of 2.17 per each reflecting surface. In order to further increase the extinction ratio, and also to turn the beam, one can utilize a double reflection as shown in FIG. 5c, wherein the total extinction ratio is approximately 4.7. Additional reflections can be utilized in order to further improve the extinction ratio. An advantage of the extra-cavity polarizer 56b of FIG. 5c over that of FIG. 5b is that it does not utilize optically contacted surfaces, and although its extinction ratio is lower, it may still be configured to achieve the desired output polarization.

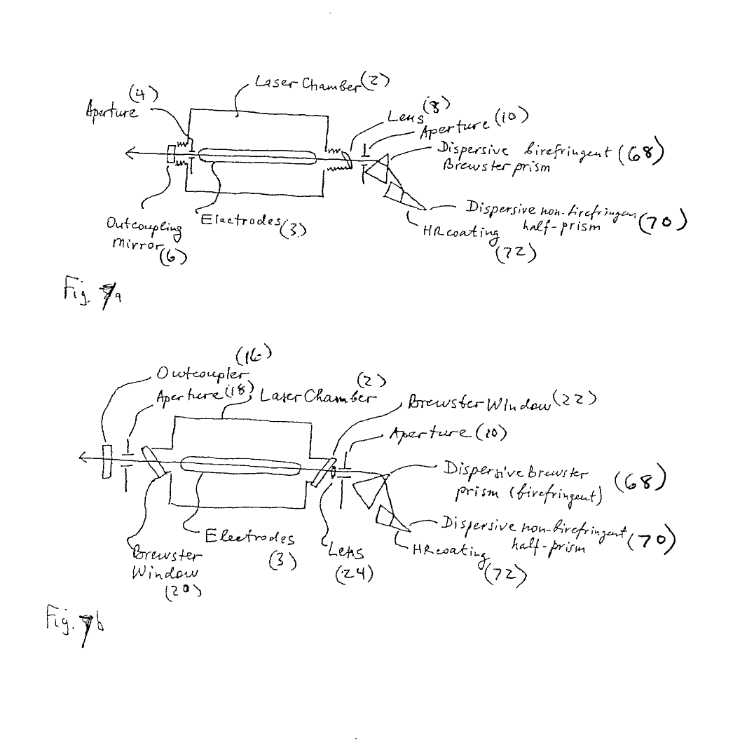

FIGS. 6a, 6b, 7a and 7b schematically show four additional embodiments of resonator designs that advantageously provide line-selection and polarization of at least 95% or 97.5% or more for a molecular fluorine laser. Some of the same elements of the resonator designs described earlier are included in these designs, have the same reference numerals as their earlier described counterparts and their description is not repeated in detail here. The embodiments shown and described with reference to FIGS. 1a, 1b and 2 included a preferred birefringent prism made of magnesium fluoride for angularly separating the beams with in-plane and out-of-plane polarization. In the embodiments shown at FIGS. 6a-6b, the dispersive prism 62 is preferably formed of CaF₂ rather than MgF₂ because with the CaF₂ prism 62, the intensity ratio of the weak line with the wavelength of 157.523 nm to the stronger line at 157.629 nm was improved to below 0.5%, due to its higher dispersivity, as compared to an intensity ratio of slightly below 2% achieved using the MgF₂ prism 12,26. A contrast ratio of 2% may be sufficient in some applications, wherein the MgF₂ prism 12,26 may be preferred due to its birefringent properties, while for other applications, a better contrast may be desired such that the CaF₂ prism 62 may then be preferred. Therefore, we describe below embodiments with advantageous spectral selectivity and adequate polarization selection.

FIGS. 6a-6b schematically show two of these additional embodiments. As shown, two prisms 62 and 64 are used instead of the one prism, i.e., any of prisms 12, 26, 34 and 42, that is preferred in the embodiments shown at FIGS. 1a-4b. The first Brewster prism 62 is made of a material with a relatively high wavelength dispersion, but which is not necessarily birefringent, e.g., CaF₂, although the prism may alternatively comprise CaF₂. The approximate apex angle of this prism 62 is 65° according to a preferred embodiment. The purpose of this prism 62 is to provide a majority of the desired wavelength resolving power of the laser resonator.

Additionally, there is a birefringent half-prism 64 made of MgF₂ that provides polarization selectivity. The back side of this half prism preferably has a dielectric coating 66 for high reflectivity at 157 nm. This prism 64 has an approximate apex angle of 34° according to a preferred embodiment, or about half of the apex angle of the MgF₂ prism 12, 26 described above. An advantage of using the half-prism 64, instead of a full prism 12, 26 in combination with a highly reflective (HR) mirror 14, is that the number of optical surfaces that the beam traverses is less and the optical beam path in the resonator is shortened. The polarization resolving power of the half prism 64 provides sufficient polarization selection. The mechanism of polarization selection here is similar to that described above and illustrated at FIG. 2, except that the beam traverses only one surface at Brewster's angle and is reflected back by the dielectric coating.

The embodiment schematically shown at FIG. 6b differs from that shown at FIG. 6a in part because Brewster windows 20, 22 are used to seal the laser chamber 2 instead of the output coupling mirror 6 and lens 8, while the output coupler 16 and lens 24 are external to the laser chamber 2. This provides an advantage in mechanical stability of the resonator, but involves a longer optical beam path and a greater number of optical surfaces, and so a balancing of these considerations can be performed to select an optimal configuration for a certain application.

Further additional embodiments are schematically shown at FIGS. 7a-7b and utilize similar principles as the embodiments of FIGS. 6a-6b, except that a full birefringent prism 68 and a half dispersive prism 70 are used instead of the prisms 62 and 64 of FIGS. 6a-6b. The dispersive birefringent Brewster prism 68 may be similar to that described above and may be configured according to any of the alternative embodiments described above. The choice between any of these embodiments may be determined by balancing the considerations of spectral selectivity and polarization selectivity, which depend on the application.

An alternative embodiment may be used including the birefringent full prism 68 of FIGS. 6a and 6b and the birefringent half prism 64 of FIGS. 7a and 7b. This embodiment may be advantageous when a very high degree of polarization selectivity is desired, although in general, one birefringent prism would provide a sufficient degree of polarization selection. Also, an embodiment including the non-birefringent full prism 62 and the non-birefringent half prism 70 may be used which provides high spectral selectivity, while the desired polarization selectivity may be achieved by including one or more of any of the various polarization components described herein.

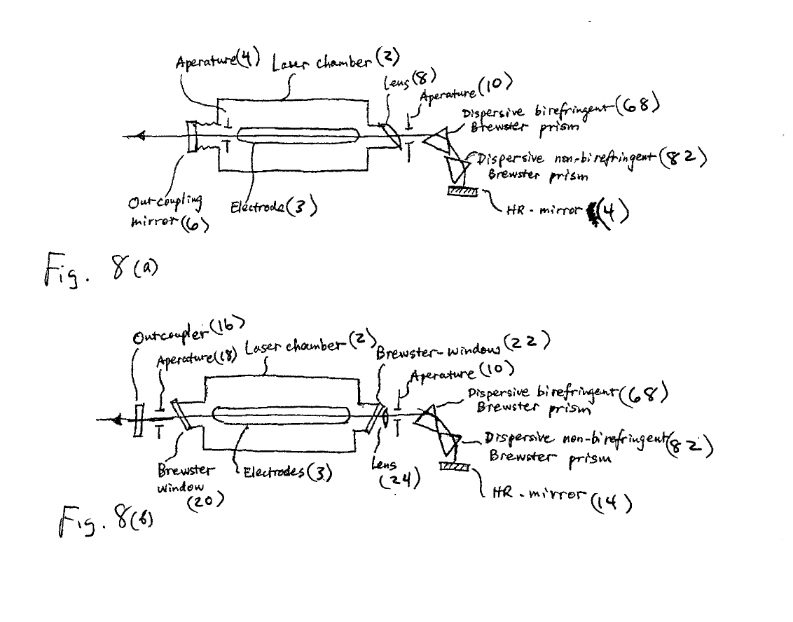

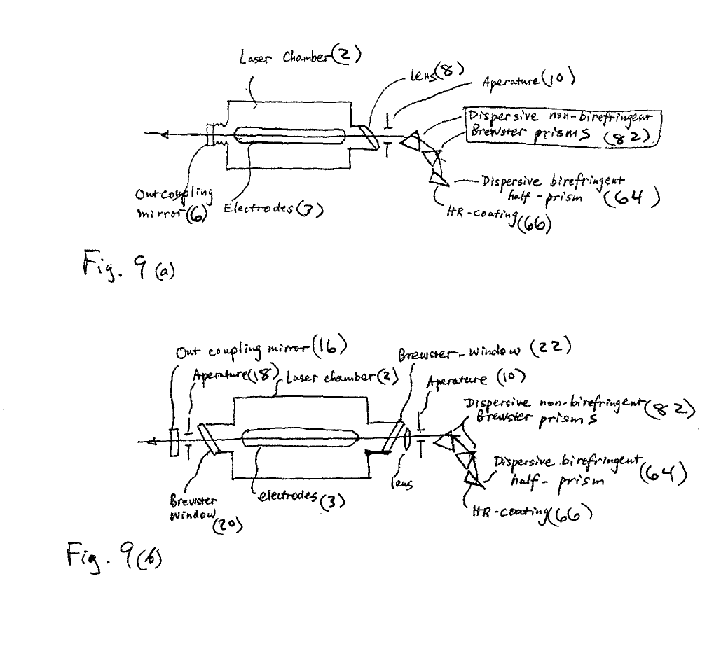

FIGS. 8a-8b and 9a-9b schematically illustrate two additional embodiments and represent the particularly preferred embodiments. The resonator of the laser system for producing a laser beam with high spectral and polarization selectivity according to the preferred embodiment of FIG. 8a includes the laser chamber 2 which is filled with a gas mixture, and electrodes 3 which are connected to a power supply circuit for energizing the gas mixture. The resonator further includes an aperture 4 within the gas mixture and an outcoupling mirror that seals the chamber 2, although the aperture and outcoupler may be replaced by the outcoupler 16 and aperture 18 arrangement of FIG. 8b. In further alternative embodiments, the aperture 4 and aperture 18 may be each excluded or may be each included or one or both may be otherwise disposed within the resonator.

The resonator of FIG. 8a further includes a lens 8, which may be substituted by lens 24 and Brewster window 22 of FIG. 8b, and aperture 10, which may be otherwise disposed in the resonator or excluded in alternative embodiments. A dispersive birefringent Brewster prism 68 and a dispersive non-birefringent Brewster prism 82 are also included and preferably formed of MgF₂ and CaF₂, respectively. A HR mirror 4 serves as a resonator reflector.

The resonator arrangement of FIG. 8b includes the laser chamber 2, electrodes 3, outcoupler 16, aperture 18, Brewster windows 20 and 22, lens 24, aperture 10, dispersive birefringent Brewster prism 68, dispersive non-birefringent Brewster prism 82 and HR mirror 14. Some alternative embodiments include modifications such as have been described above, switching the prisms 68 and 82, disposing the aperture 10 between or after the prisms 68 and 82 or including an additional such aperture. The outcoupler 16, aperture 18 and window 20 may be replaced by the outcoupler 6 and aperture 4 of the embodiment of FIG. 8a. The window 22 and lens 24 may be replaced by the lens 8 of FIG. 8a. Other alternatives described above with reference to FIG. 8a may be combined into the arrangement of FIG. 8b.

The resonator arrangements of FIGS. 9a-9b are preferably the same as or similar to those described above with reference to FIGS. 8a-8b such that descriptions of same or similar elements are incorporated and not repeated here. The arrangements of FIG. 9a-9b include the following differences from those of FIGS. 8a-8b. The dispersive birefringent Brewster prism 68 of FIGS. 8a-8b has been replace by a second dispersive non-birefringent Brewster prism 82. The HR mirror 4 or 14 of FIGS. 8a-8b has been replaced by a dispersive birefringent half-prism 64 with a HR coating 66 serving as a resonator reflector surface, similar to or the same as that described above with reference to FIGS. 6a-6b.

A difference between the embodiments of FIGS. 8a-9b and those of FIGS. 1a-1b and 6a-7b is in the number of prisms used. The non-birefringent prisms 82 preferably made of calcium fluoride serve advantageously to provide a high degree of wavelength selectivity of the optical resonator, and a higher degree than would be provided if one or more of the non-birefringent prisms 82 were replaced by birefringent prisms 68 preferably made of magnesium fluoride. Calcium fluoride has a higher value of wavelength dispersion of its refractive index than that of MgF₂. It is therefore advantageously recognized herein that it is generally beneficial to use CaF₂ instead of MgF₂ when it is desired to increase wavelength selectivity. Our experiments showed that a single MgF₂ prism 68, or even a half-prism 64 made of MgF₂, provide sufficient selectivity of polarization. For example, each of the preferred embodiments schematically illustrated at FIGS. 8a, 8b, 9a and 9b provide an output polarization degree above 98%, which is, of course, advantageously above each of the desired 95% and 97.5% polarization percentages. At the same time, wavelength selectivity of a single prism 68, or half-prism 64, of MgF₂ is typically insufficient, by itself, for suppressing the intensity of the secondary spectral line (i.e., λ₂≈157.523 nm, where λ₁≈157.629 nm) to below 1%, as is desired for photolithographic applications of the preferred molecular fluorine laser system. The additional one or two (or alternatively more) prisms of the embodiments of FIGS. 8a-9b advantageously provide both polarization selectivity above 98%, which is again above the desired 95% and 97.5% thresholds, and also provide secondary spectral line suppression to below 1 %.

The extra prism 82 of each of the embodiments of FIGS. 8a-9b is preferably and advantageously formed of CaF₂, which is a material having a higher magnitude of wavelength dispersion than MgF₂, even though the prism 82 is preferably not birefringent due to the polarization having otherwise already been taken care of. Note that the non-birefringent prism 82 may be replaced by a birefringent prism 68 in an alternative embodiment to produce an embodiment with greater polarization selectivity, if desired, while the suppression of the secondary line would be somewhat reduced. The choice between any of the embodiments of FIGS. 8a-9b may be determined by factors such as manufacturing cost, lifetime of components, etc., while each of the embodiments of FIGS. 8a-9b have suppression ratio of the secondary spectral line to well below 1%.

The preferred and alternative embodiments set forth above are designed to produce linearly polarized output. However, if for any reason, any other state of polarization (e.g., circular or elliptical) is desired, a waveplate may be preferably used, e.g., made of magnesium fluoride, that will produce such polarization from an otherwise linearly polarized output, and the term “polarization” or “polarized” as used herein is meant to include linear, circular and elliptical polarizations.

### Overall Laser System

FIG. 10 schematically illustrates an overall molecular fluorine (F₂) laser system according to a preferred embodiment. Referring to FIG. 10, a molecular fluorine laser system is schematically shown according to a preferred embodiment (some of the features of the preferred embodiment set forth herein may also be applied to excimer lasers such as ArF and KrF excimer lasers, and even some to EUV lithography around 11 nm to 15 nm, and so some description of alternatives for these lasers is described below). The preferred gas discharge laser system is a VUV laser system, such as a molecular fluorine (F₂) laser system. Alternative configurations for laser systems for use in such other industrial applications as TFT annealing, photoablation and/or micromachining, e.g., include configurations understood by those skilled in the art as being similar to and/or modified from the system shown in FIG. 10 to meet the requirements of that application. For this purpose, alternative configurations are described at U.S. patent applications Ser. Nos. 09/317,695, 09/244,554, 09/452,353, 09/512,417, 09/599,130, 09/694,246, 09/712,877, 09/574,921, 09/738,849, 09/718,809, 09/629,256, 09/712,367, 09/771,366, 09/715,803, 09/738,849, Nos. 60/202,564, 60/204,095, Ser. Nos. 09/741,465, 09/574,921, 09/734,459, 09/741,465, 09/686,483, 09/715,803, and 09/780,124, and U.S. Pat. Nos. 6,005,880, 6,061,382, 6,020,723, 5,946,337, 6,014,206, 6,157,662, 6,154,470, 6,160,831, 6,160,832, 5,559,816, 4,611,270, 5,761,236, 6,212,214, 6,154,470, 6,298,080, 6,285,701, 6,272,158, 6,269,110 and 6,157,662, and EUV systems are set forth at U.S. patent applications No. 60/281,446, Ser. No. 09/693,490 and No. 60/312,277, and references cited in those applications, each of which is assigned to the same assignee as the present application and is hereby incorporated by reference.

The system shown in FIG. 10 generally includes a laser chamber 102 (or laser tube including a heat exchanger and fan for circulating a gas mixture within the chamber 102 or tube) having a pair of main discharge electrodes 103 connected with a solid-state pulser module 104, and a gas handling module 106. The gas handling module 106 has a valve connection to the laser chamber 102 so that active halogen and rare gases and buffer gases, and optionally a gas additive, may be injected or filled into the laser chamber 102, preferably in premixed forms (see U.S. patent application Ser. No. 09/513,025, which is assigned to the same assignee as the present application, and U.S. Pat. No. 4,977,573, which are each hereby incorporated by reference) for ArF, XeCl and KrF excimer lasers, among others, and halogen and buffer gases, and any gas additive, for the F₂ laser. For the high power XeCl laser, the gas handling module may or may not be present in the overall system. The solid-state pulser module 104 is powered by a high voltage power supply 108. A thyratron pulser module may alternatively be used. The laser chamber 102 is surrounded by optics module 110 (or the rear optics module ROM) and optics module 112 (or the front optics module FOM), forming a resonator. The optics modules may include only a highly reflective resonator reflector in the rear optics module 110 and a partially reflecting output coupling mirror in the front optics module 112, such as is preferred for the high power XeCl laser, wherein line-narrowing is not desired. The optics modules 110 and 112 may be controlled by an optics control module 114, or may be alternatively directly controlled by a computer or processor 116, particular when line-narrowing optics are included in one or both of the optics modules 110, 112, such as is preferred when KrF, ArF or F₂ lasers are used for optical lithography.

The processor 116 for laser control receives various inputs and controls various operating parameters of the system. A diagnostic module 118 (note that even though the diagnostic module 118 is shown as a single block in FIG. 10, this is illustrative and multiple modules may be used for diagnostic purposes that are not coupled together or included within a single structural module 118, although multiple extra-cavity modules, e.g., wavemeter, energy detector, wavelength calibration module, etc., may be enclosed in a common housing), receives and measures one or more parameters, such as pulse energy, average energy and/or power, and preferably wavelength, of a split off portion of the main beam 120 via optics for deflecting a small portion of the beam toward the module 118, such as preferably a beam splitter module 122 (see, e.g, U.S. patent applications Ser. Nos. 09/598,552 and 09/718,809, which are assigned to the same assignee as the present application and are hereby incorporated by reference). The beam 120, which preferably passes through (or is blocked by) a shutter module (not shown) is preferably the laser output to an imaging system (not shown) and ultimately to a workpiece (also not shown) such as particularly for lithographic applications, and may be output directly to an application process. The laser control computer 116 may communicate through an interface 124 with a stepper/scanner computer, other control units 126, 128 and/or other external systems.

### Laser Chamber

The laser chamber 102 contains a laser gas mixture and includes one or more preionization electrodes (not shown) in addition to the pair of main discharge electrodes 103. Preferred main electrodes 103 are described at U.S. patent application Ser. No. 09/453,670 for photolithographic applications, which is assigned to the same assignee as the present application and is hereby incorporated by reference, and may be alternatively configured, e.g., when a narrow discharge width is not preferred. Other electrode configurations are set forth at U.S. Pat. Nos. 5,729,565 and 4,860,300, each of which is assigned to the same assignee, and alternative embodiments are set forth at U.S. Pat. Nos. 4,691,322, 5,535,233 and 5,557,629, all of which are hereby incorporated by reference. Preferred preionization units may include corona-type units that emit UV radiation in a direction of the discharge region between the main electrodes 103, such as including a first electrode within a dielectric tube and a counter-electrode outside and near the outer surface of the tube, or sliding surface units, such as include a dielectric surface disposed between a pair of electrodes for allowing a sliding surface discharge to move along the sliding surface and emit UV radiation directed at the discharge region, are set forth at U.S. patent applications Ser. No. 09/692,265 (particularly preferred for KrF, ArF, F₂ lasers), U.S. Ser. Nos. 09/532,276, 09/922,241 and 09/247,887, each of which is assigned to the same assignee as the present application, and alternative embodiments are set forth at U.S. Pat. Nos. 5,337,330, 5,818,865 and 5,991,324, all of the above patents and patent applications being hereby incorporated by reference.

### Solid State Pulser Module

The solid-state or thyratron pulser module 104 and high voltage power supply 108 supply electrical energy in compressed electrical pulses to the preionization and main electrodes 103 within the laser chamber 102 to energize the gas mixture. Components of the preferred pulser module and high voltage power supply may be described at U.S. patent applications Ser No. 09/640,595, Nos. 60/198,058, 60/204,095, Ser. Nos. 09/432,348 and 09/390,146, and No. 60/204,095, and U.S. Pat. Nos. 6,005,880, 6,226,307 and 6,020,723, each of which is assigned to the same assignee as the present application and which is hereby incorporated by reference into the present application. Other alternative pulser modules are described at U.S. Pat. Nos. 5,982,800, 5,982,795, 5,940,421, 5,914,974, 5,949,806, 5,936,988, 6,028,872, 6,151,346 and 5,729,562, each of which is hereby incorporated by reference.

The laser chamber 102 is sealed by windows substantially transparent to the wavelengths of the emitted laser radiation 120. The windows may be Brewster windows 20, 22 (see FIGS. 1b, 3b, 6b, 7b, 8b and 9b) or may be aligned at another angle, e.g., 5°, to the optical path of the resonating beam, or may be optical components that serve additional functions such as the output coupler 6 and/or lens 8 of FIGS. 1a, 3a, 6a, 7a, 8s and 9a. One of the windows may serve to output couple the beam or as a highly reflective resonator reflector on the opposite side of the chamber 102 as the beam is outcoupled, and one or both of the windows may serve other functions such as being a prism or lens for line-narrowing and/or line-selection or for collimating the beam or correcting wavefront curvature.

### Laser Resonator

The laser resonator which surrounds the laser chamber 102 containing the laser gas mixture includes optics module 110 preferably including line-selection optics for a line-selected molecular fluorine laser such as for photolithography, which may be replaced by a high reflectivity mirror or the like in a laser system wherein either line-narrowing is not desired (for TFT annealling, e.g.), or if line narrowing is performed at the front optics module 112, or if a spectral filter external to the resonator is used, or if the line-narrowing optics are disposed in front of the HR mirror, for narrowing the bandwidth of the output beam. In accord with a preferred embodiment of a molecular fluorine laser system, optics for selecting one of multiple lines around 157 nm may be used, e.g., one or more dispersive prisms, interferometric devices or birefringent plates or blocks, wherein additional line-narrowing optics for narrowing the selected line may be included or left out. The total gas mixture pressure may be lower than conventional systems, e.g., lower than 3 bar, for producing the selected line at a narrow bandwidth such as 0.5 pm or less even if additional line-narrowing optics are not used (see U.S. patent application Ser. Nos. 09/883,128 and 09/923,770, which are assigned to the same assignee as the present application and are hereby incorporated by reference).

Either no optics or merely a simple, not very lossy optical configuration for line-selection may be all that is included. That is, the preferred embodiment may not have additional line-narrowing optics in the laser resonator, or includes only line-selection optics for selecting the main line at λ₁≈157.629 nm and suppressing any other lines around 157 nm that may be naturally emitted by the F₂ laser. Therefore, in one embodiment, the optics module 110 has only a highly reflective resonator mirror, and the optics module 112 has only a partially reflective resonator reflector. In another embodiment, suppression of the other lines (i.e., other than λ₁) around 157 nm is performed preferably according to any of the embodiments described above or otherwise, e.g., by an outcoupler having a partially reflective inner surface and being made of a block of birefringent material or a VUV transparent block with a coating, either of which has a transmission spectrum which is periodic due to interference and/or birefringence, and has a maximum at λ₁ and a minimum at a secondary line (see U.S. patent application Ser. Nos. 09/883,127 and 09/317,695, which are assigned to the same assignee as the present application and are hereby incorporated by reference). In another embodiment, optics such as a dispersive prism or prisms may be used for line-selection only, and not for narrowing of the main line at λ₁. Other line selection embodiments are set forth at U.S. patent applications Ser. Nos. 09/317,695, 09/657,396, and 09/599,130, which are assigned to the same assignee as the present application and are hereby incorporated by reference. The gas mixture pressure may be low enough to enable a narrow bandwidth, e.g., below 0.5 pm, even without further narrowing of the main line at λ₁ using additional optics, although such additional optics may be used, particularly in embodiments wherein an amplifier is used to increase the energy of the line-narrowed laser beam.

Optics module 112 preferably includes an output coupler 120 (or means for outcoupling the beam), such as a partially reflective resonator reflector. The beam 120 may be otherwise outcoupled such as by an intra-resonator beam splitter or partially reflecting surface of another optical element, and the optics module 112 would in this case include a highly reflective mirror. The optics control module 114 preferably controls the optics modules 1 10 and 112 such as by receiving and interpreting signals from the processor 116, and initiating realignment, gas pressure adjustments in the modules 110, 112, or reconfiguration procedures (see the '353, '695, '277, '554, and '396 applications mentioned above).

### Diagnostic Module

After a portion of the output beam 120 passes the outcoupler of the optics module 112, that output portion preferably impinges upon a beam splitter module 122 which includes optics for deflecting a portion of the beam to the diagnostic module 118, or otherwise allowing a small portion of the outcoupled beam to reach the diagnostic module 118, while a main beam portion 120 is allowed to continue as the output beam 120 of the laser system (see U.S. patent application Ser. Nos. 09/771,013, 09/598,552, and 09/712,877 which are assigned to the same assignee as the present invention, and U.S. Pat. No. 4,611,270, each of which is hereby incorporated by reference. Preferred optics include a beamsplitter or otherwise partially reflecting surface optic. The optics may also include a mirror or beam splitter as a second reflecting optic. More than one beam splitter and/or HR mirror(s), and/or dichroic mirror(s) may be used to direct portions of the beam to components of the diagnostic module 118, as described above, e.g., a wavemeter and an absolute wavelength calibration module may be separate from each other and from an energy detector module. A holographic beam sampler, transmission grating, partially transmissive reflection diffraction grating, grism, prism or other refractive, dispersive and/or transmissive optic or optics may also be used to separate a small beam portion from the main beam 120 for detection at the diagnostic module 118, while allowing most of the main beam 120 to reach an application process directly or via an imaging system or otherwise. These optics or additional optics may be used to filter out visible radiation such as the red emission from atomic fluorine in the gas mixture from the split off beam prior to detection (see the Ser. No. 09/598,552 application, mentioned above, and U.S. patent application Ser. No. 09/712,877, which is assigned to the same assignee as the present application and is hereby incorporated by reference).

The output beam 120 may be transmitted at the beam splitter module while a reflected beam portion is directed at the diagnostic module 118, or the main beam 120 may be reflected, while a small portion is transmitted to the diagnostic module 118. The portion of the outcoupled beam that continues past the beam splitter module 122 is the output beam 120 of the laser, which propagates toward an industrial or experimental application such as an imaging system and workpiece for photolithographic applications.

The diagnostic module 118 preferably includes at least one energy detector. This detector measures the total energy of the beam portion that corresponds directly to the energy of the output beam 120 (see U.S. Pat. Nos. 4,611,270 and 6,212,214 which are hereby incorporated by reference). An optical configuration such as an optical attenuator, e.g., a plate or a coating, or other optics may be formed on or near the detector or beam splitter module 122 to control the intensity, spectral distribution and/or other parameters of the radiation impinging upon the detector (see U.S. patent application Ser Nos. 09/172,805, 09/741,465, 09/712,877, 09/771,013 and 09/771,366, each of which is assigned to the same assignee as the present application and is hereby incorporated by reference).

One other component of the diagnostic module 118 is preferably a wavelength and/or bandwidth detection component such as a monitor etalon or grating spectrometer (see U.S. patent application Ser. Nos. 09/416,344, 09/686,483, and 09/791,431, each of which is assigned to the same assignee as the present application, and U.S. Pat. Nos. 4,905,243, 5,978,391, 5,450,207, 4,926,428, 5,748,346, 5,025,445, 6,160,832, 6,160,831 and 5,978,394, all of the above wavelength and/or bandwidth detection and monitoring components being hereby incorporated by reference. The bandwidth may be monitored and controlled in a feedback loop including the processor 116 and gas-handling module 106. The total pressure of the gas mixture in the laser tube 102 may be controlled to a particular value for producing an output beam at a particular bandwidth.

Other components of the diagnostic module may include a pulse shape detector or ASE detector, such as are described at U.S. Pat. Nos. 6,243,405 and 6,243,406, respectively, which are hereby incorporated by reference, such as for gas control and/or output beam energy stabilization, or to monitor the amount of amplified spontaneous emission (ASE) within the beam to ensure that the ASE remains below a predetermined level, as set forth in more detail below. There may be a beam alignment monitor, e.g., such as is described at U.S. Pat. Nos. 6,014,206, or beam profile monitor, e.g., U.S. patent application Ser No. 09/780,124, which is assigned to the same assignee, wherein each of these patent documents is hereby incorporated by reference.

### Beam Path Enclosures

Particularly for the preferred molecular fluorine laser system, an enclosure 130 preferably seals the beam path of the beam 120 such as to keep the beam path free of photoabsorbing species and/or scattering particulate species. Smaller enclosures 132 and 134 preferably seal the beam path between the chamber 102 and the optics modules 110 and 112, respectively, and a further enclosure 136 is disposed between the beam splitter 122 and the diagnostic module 118. Preferred enclosures are described in detail in U.S. patent application Ser. Nos. 09/598,552, 09/594,892 and 09/131,580, which are assigned to the same assignee and are hereby incorporated by reference, and U.S. Pat. Nos. 6,219,368, 5,559,584, 5,221,823, 5,763,855, 5,811,753 and 4,616,908, all of which are hereby incorporated by reference. The enclosure may be evacuated or purged with an inert gas. The optics modules 110 and 112, as well as any of the other modules, may themselves also be maintained substantially free of photoabsorbing species preferably as described above using a purge gas flow mechanism, wherein one or both modules may alternatively be evacuated, particularly the rear optics module 110, or the front optics module if the line-narrowing is performed there (see U.S. patent application No. 60/281,433, which is assigned to the same assignee as the present application and is hereby incorporated by reference), and alternatively one or more modules may be filled with a stagnant (i.e., non-flowing) inert gas and sealed from the outer atmosphere.

### Processor Control

The processor or control computer 116 receives and processes values of some of the pulse shape, energy, ASE, energy stability, energy overshoot for burst mode operation, wavelength, spectral purity and/or bandwidth, among other input or output parameters of the laser system and output beam. The processor 116 also controls the line narrowing module to tune the wavelength and/or bandwidth or spectral purity, and controls the power supply and pulser module 104 and 108 to control preferably the moving average pulse power or energy, such that the energy dose at points on the workpiece is stabilized around a desired value. In addition, the computer 116 controls the gas-handling module 106 which includes gas supply valves connected to various gas sources. Further functions of the processor 116 such as to provide overshoot control, energy stability control and/or to monitor input energy to the discharge, are described in more detail at U.S. patent application Ser. No. 09/588,561, which is assigned to the same assignee and is hereby incorporated by reference.

As shown in FIG. 10, the processor 116 preferably communicates with the solid-state or thyratron pulser module 104 and HV power supply 108, separately or in combination, the gas handling module 106, the optics modules 110 and/or 112, the diagnostic module 118, and an interface 124. The laser resonator which surrounds the laser chamber 102 containing the laser gas mixture includes optics module 110 including line-narrowing optics for a line narrowed excimer or molecular fluorine laser, which may be replaced by a high reflectivity mirror or the like in a laser system wherein either line-narrowing is not desired, or if line narrowing is performed at the front optics module 112, or an spectral filter external to the resonator is used for narrowing the linewidth of the output beam.

### Gas Mixture

The laser gas mixture is initially filled into the laser chamber 102 in a process referred to herein as a “new fills”. In such procedure, the laser tube is evacuated of laser gases and contaminants, and re-filled with an ideal gas composition of fresh gas. The gas composition for a very stable excimer or molecular fluorine laser in accord with the preferred embodiment uses helium or neon or a mixture of helium and neon as buffer gas(es), depending on the particular laser being used. Preferred gas compositions are described at U.S. Pat. Nos. 4,393,405, 6,157,662 and 4,977,573 and U.S. patent application Ser. Nos. 09/513,025, 09/447,882, 09/418,052, and 09/588,561, each of which is assigned to the same assignee and is hereby incorporated by reference into the present application. The concentration of the fluorine in the gas mixture may range from 0.003% to 1.00%, and is preferably around 0.1%. An additional gas additive, such as a rare gas or otherwise, may be added for increased energy stability, overshoot control and/or as an attenuator as described in the Ser. No. 09/513,025 application incorporated by reference above. Specifically, for the F₂-laser, an addition of xenon, krypton and/or argon may be used. The concentration of xenon or argon in the mixture may range from 0.0001% to 0.1%. For an ArF-laser, an addition of xenon or krypton may be used also having a concentration between 0.0001% to 0.1%. For the KrF laser, an addition of xenon or argon may be used also having a concentration between 0.0001% to 0.1%. Although the preferred embodiments herein are particularly drawn to use with a F₂ laser, some gas replenishment actions are described for gas mixture compositions of other systems such as ArF, KrF, and XeCl excimer lasers, wherein the ideas set forth herein may also be advantageously incorporated into those systems.

Also, the gas composition for the F₂ laser in the above configurations uses either helium, neon, or a mixture of helium and neon as a buffer gas. The concentration of fluorine in the buffer gas preferably ranges from 0.003% to around 1.0%, and is preferably around 0.1%. However, if the total pressure is reduced for narrowing the bandwidth, then the fluorine concentration may be higher than 0.1%, such as may be maintained between 1 and 7 mbar, and more preferably around 3-5 mbar, notwithstanding the total pressure in the tube or the percentage concentration of the halogen in the gas mixture. The addition of a trace amount of xenon, and/or argon, and/or oxygen, and/or krypton and/or other gases (see the '025 application) may be used for increasing the energy stability, burst control, and/or output energy of the laser beam. The concentration of xenon, argon, oxygen, or krypton in the mixture may range from 0.0001 % to 0.1%, and would be preferably significantly below 0.1%. Some alternative gas configurations including trace gas additives are set forth at U.S. patent application Ser. No. 09/513,025 and U.S. Pat. No. 6,157,662, each of which is assigned to the same assignee and is hereby incorporated by reference.

Preferably, a mixture of 5% F₂ in Ne with He as a buffer gas is used, although more or less He or Ne may be used. The total gas pressure may be advantageously adjustable between 1500 and 4000 mbar for adjusting the bandwidth and/or spectral purity of the laser, and also optionally for adjusting the wavelength and/or energy of the beam (see the Ser. Nos. 09/883,128 and 09/780,120 applications, mentioned above). The partial pressure of the buffer gas is preferably adjusted to adjust the total pressure, such that the amount of molecular fluorine in the laser tube is not varied from an optimal, pre-selected amount, although the molecular fluorine is otherwise replenished as its concentration deteriorates due to the corrosive action of the aggressive halogen. The bandwidth and spectral purity are shown to advantageously decrease with decreased He and/or Ne buffer gas in the gas mixture. Thus, the partial pressure of the He and/or Ne in the laser tube is adjustable to adjust the bandwidth of the laser emission.

### Gas Mixture Replenishment

Halogen gas injections, including micro-halogen injections of, e.g., 1-3 milliliters of halogen gas, mixed with, e.g., 20-60 milliliters of buffer gas or a mixture of the halogen gas, the buffer gas and a active rare gas for rare gashalide excimer lasers, per injection for a total gas volume in the laser tube 102 of, e.g., 100 liters, total pressure adjustments and gas replacement procedures may be performed using the gas handling module 106 preferably including a vacuum pump, a valve network and one or more gas compartments. The gas-handling module 106 receives gas via gas lines connected to gas containers, tanks, canisters and/or bottles. Some preferred and alternative gas handling and/or replenishment procedures, other than as specifically described herein (see below), are described at U.S. Pat. Nos. 4,977,573, 6,212,214 and 5,396,514 and U.S. patent applications Ser. Nos. 09/447,882, 09/418,052, 09/734,459, 09/513,025 and 09/588,561, each of which is assigned to the same assignee as the present application, and U.S. Pat. Nos. 5,978,406, 6,014,398 and 6,028,880, all of which are hereby incorporated by reference. A xenon gas supply may be included either internal or external to the laser system according to the '025 application, mentioned above.

Total pressure adjustments in the form of releases of gases or reduction of the total pressure within the laser tube 102 may also be performed. Total pressure adjustments may be followed by gas composition adjustments if it is determined that, e.g., other than the desired partial pressure of halogen gas is within the laser tube 102 after the total pressure adjustment. Total pressure adjustments may also be performed after gas replenishment actions, and may be performed in combination with smaller adjustments of the driving voltage to the discharge than would be made if no pressure adjustments were performed in combination.

Gas replacement procedures may be performed and may be referred to as partial, mini- or macro-gas replacement operations, or partial new fill operations, depending on the amount of gas replaced, e.g., anywhere from a few milliliters up to 50 liters or more, but less than a new fill, such as are set forth in the Ser. No. 09/734,459 application, incorporated by reference above. As an example, the gas handling unit 106 connected to the laser tube 102 either directly or through an additional valve assembly, such as may include a small compartment for regulating the amount of gas injected (see the '459 application), may include a gas line for injecting a premix A including 1% F₂:99% Ne or other buffer gas such as He, and another gas line for injecting a premix B including 1% rare gas:99% buffer gas, for a rare gas-halide excimer laser, wherein for a F₂ laser premix B is not used. Another line may be used for total pressure additions or reductions, i.e., for flowing buffer gas into the laser tube or allowing some of the gas mixture in the tube to be released, possibly accompanying halogen injections for maintaining the halogen concentration. Thus, by injecting premix A (and premix B for rare gas-halide excimer lasers) into the tube 102 via the valve assembly, the fluorine concentration in the laser tube 102 may be replenished. Then, a certain amount of gas may be released corresponding to the amount that was injected to maintain the total pressure at a selected level. Additional gas lines and/or valves may be used for injecting additional gas mixtures. New fills, partial and mini gas replacements and gas injection procedures, e.g., enhanced and ordinary micro-halogen injections, such as between 1 milliliter or less and 310 milliliters, and any and all other gas replenishment actions are initiated and controlled by the processor 116 which controls valve assemblies of the gas handling unit 106 and the laser tube 102 based on various input information in a feedback loop. These gas replenishment procedures may be used in combination with gas circulation loops and/or window replacement procedures to achieve a laser system having an increased servicing interval for both the gas mixture and the laser tube windows.

The halogen concentration, or the total amount of halogen in mbar, in the gas mixture is maintained constant during laser operation by gas replenishment actions by replenishing the amount of halogen in the laser tube for the preferred molecular fluorine laser herein, such that these gases are maintained in a same predetermined ratio as are in the laser tube 102 following a new fill procedure, or such that the molecular fluorine is maintained at a same partial pressure as is present in the laser tube 102 after a new fill procedure. In addition, gas injection actions such as μHIs as understood from the '882 application, mentioned above, may be advantageously modified into micro gas replacement procedures, such that the increase in energy of the output laser beam may be compensated by reducing the total pressure. In contrast, or alternatively, conventional laser systems would reduce the input driving voltage so that the energy of the output beam is at the predetermined desired energy. In this way according to a preferred embodiment, the driving voltage is maintained within a small range around HVₒₚₜ, while the gas procedure operates to replenish the gases and maintain the average pulse energy or energy dose, such as by controlling an output rate of change of the gas mixture or a rate of gas flow through the laser tube 102. Advantageously, the gas procedures set forth herein permit the laser system to operate within a very small range around HVₒₚₜ, while still achieving average pulse energy control and gas replenishment, and increasing the gas mixture lifetime or time between new fills (see U.S. patent application Ser. No. 09/780,120, which is assigned to the same assignee as the present application and is hereby incorporated by reference).

### Line Narrowing

A general description of the line-narrowing features of embodiments of the laser system particularly for use with photolithographic applications is provided here, followed by a listing of patent and patent applications being incorporated by reference as describing variations and features that may be used within the scope of the preferred embodiments herein for providing an output beam with a high spectral purity or bandwidth (e.g., below 1 pm and preferably 0.6 pm or less). Although the preferred embodiments have already been set forth above, these exemplary embodiments may also be used, e.g., for selecting the primary line λ₁ only, or may be used to provide additional line narrowing as well as performing line-selection when a very narrow linewidth is desired, or the resonator may include optics for line-selection and additional optics for line-narrowing of the selected line, and line-narrowing may be provided by controlling (i.e., reducing) the total pressure (see U.S. patent application No. 60/212,301, which is assigned to the same assignee and is hereby incorporated by reference). Exemplary line-narrowing optics contained in the optics module 110 include one or more full or half dispersion prisms, a beam expander, an interferometric device such as an etalon or otherwise as described in the Ser. No. 09/715,803 application, incorporated by reference above, and/or a diffraction grating, wherein the grating would produce a relatively higher degree of dispersion than the prisms although generally exhibiting somewhat lower efficiency than the dispersion prism or prisms at 157 nm (wherein the grating is preferred for use with the ArF laser due to its greater dispersion being advantageous for narrowing the 400 pm characteristic broadband emission spectrum of the ArF laser and because the grating has greater efficiency at 193 nm), for a narrow band laser such as is used with a refractive or catadioptric optical lithography imaging system. As mentioned above, the front optics module 112 may include line-narrowing optics such as may be described in any of the Ser. Nos. 09/715,803, 09/738,849, and 09/718,809 applications, each being assigned to the same assignee and hereby incorporated by reference.

Instead of having a retro-reflective grating in the rear optics module 110, the grating may be replaced with a highly reflective mirror, and a lower degree of dispersion may be produced by a dispersive prism or alternatively no line-narrowing or line-selection may be performed in the rear optics module 110. In the case of using an all-reflective imaging system, the laser may be configured for semi-narrow band operation such as having an output beam linewidth in excess of 0.6 pm, depending on the characteristic broadband bandwidth of the laser, such that additional line-narrowing of the selected line would not be used, either provided by optics or by reducing the total pressure in the laser tube.

A beam expander, if used, would preferably include one or more beam expansion prisms. The beam expander may include other beam expanding optics such as a lens assembly or a converging/diverging lens pair, and the beam expander may employ reflective optics as is understood from Babinet's principle. The grating or a highly reflective mirror is preferably rotatable so that the wavelengths reflected into the acceptance angle of the resonator can be selected or tuned. Alternatively, the grating, or other optic or optics, or the entire line-narrowing module may be pressure tuned, such as is set forth in the Ser. No. 09/771,366 application and the U.S. Pat. No. 6,154,470 patent, each of which is assigned to the same assignee and is hereby incorporated by reference. The grating or dispersion prism may be used both for dispersing the beam for achieving narrow bandwidths and also for retroreflecting the beam back toward the laser tube. Alternatively, a highly reflective mirror or other reflective surface is positioned after the grating or prism which may receive a reflection from the grating or refract through the prism, etc., and reflects the beam back toward the prism or grating, or a mirror may be disposed between the prism or grating and a beam expander or wavefront compensation optic, and a Littman configuration may be used, or the grating may be a transmission grating. One or more dispersive prisms may also be used, and more than one etalon or other interferometric device may be used.

One or more apertures may be included in the resonator for blocking stray light and matching the divergence of the resonator (see the U.S. Pat. No. 6,285,701 patent, mentioned above). As mentioned above, the front optics module 112 may include line-narrowing optics (see the Ser. Nos. 09/715,803, 09/738,849 and 09/718,809 applications, each being assigned to the same assignee as the present application and hereby incorporated by reference), including or in addition to the outcoupler element.

Depending on the type and extent of line-narrowing and/or selection and tuning that is desired, and the particular laser that the line-narrowing optics are to be installed into, there are many alternative optical configurations that may be used other than those specifically mentioned herein. For this purpose, those described in U.S. Pat. Nos. 4,399,540, 4,905,243, 5,226,050, 5,559,816, 5,659,419, 5,663,973, 5,761,236, 6,081,542, 6,061,382, 6,154,470, 5,946,337, 5,095,492, 5,684,822, 5,835,520, 5,852,627, 5,856,991, 5,898,725, 5,901,163, 5,917,849, 5,970,082, 5,404,366, 4,975,919, 5,142,543, 5,596,596, 5,802,094, 4,856,018, 5,970,082, 5,978,409, 5,999,318, 5,150,370 and 4,829,536, and German patent DE 298 22 090.3, and any of the other patents and/or patent applications mentioned above and below herein, may be consulted to obtain a line-narrowing configuration that may be used with a preferred laser system herein, and each of these patent references is each hereby incorporated by reference into the present application.

As discussed, there may be no line-narrowing optics in the resonator, in some embodiments, that are subject to degradation or produce losses, wherein alternatively, only optics to select a single line (i.e., λ₁) may be used in a F₂ laser system. However, line-narrowing optics may be used for further line-narrowing in combination with the line-narrowing and/or bandwidth adjustment that may be performed by adjusting/reducing the total pressure in the laser chamber (for the ArF laser, and for the KrF laser, line-narrowing optics at least including a grating and beam expander, and optionally an interferometric device, are particularly preferred, e.g., see U.S. patent application Ser. Nos. 09/712,367, 09/715,803 and 60/280,398, which are assigned to the same assignee as the present application and are hereby incorporated by reference). For example, a natural bandwidth may be adjusted to 0.5 pm by reducing the partial pressure of the buffer gas to 1000-1500 mbar. The bandwidth could than be reduced to 0.2 pm or below using line-narrowing optics either in the resonator or external to the resonator.

### Optical Materials

In all of the above and below embodiments, the material used for any dispersive prisms, the prisms of any beam expanders, etalons, laser windows and the outcoupler is preferably one that is highly transparent at the 157 nm output emission wavelength of the molecular fluorine laser. The materials are also capable of withstanding long-term exposure to ultraviolet light with minimal degradation effects, particularly at high repetition rates such as 2, 4 or 8 kHz or higher. Examples of such materials are CaF₂, MgF₂, BaF₂, LiF and SrF₂, and in some cases fluorine-doped quartz may be used. As mentioned above, MgF₂ is preferably used when a birefringent material is desired, and CaF₂ is the preferred non-birefringent material. Also, in all of the embodiments, many optical surfaces, particularly those of the prisms, may or may not have an anti-reflective coating on one or more optical surfaces, in order to minimize reflection losses and prolong their lifetime.

### Power Amplifier

A line-narrowed oscillator, e.g., a set forth above, may be followed by a power amplifier for increasing the power of the beam output by the oscillator. Preferred features of the oscillator-amplifier set-up are set forth at U.S. patent application Ser. Nos. 09/599,130 and 09/923,770, which are assigned to the same assignee and are hereby incorporated by reference. The amplifier may be the same or a separate discharge chamber 102. An optical or electrical delay may be used to time the electrical discharge at the amplifier with the reaching of the optical pulse from the oscillator at the amplifier. The molecular fluorine laser oscillator may have an advantageous output coupler having a transmission interference maximum at λ₁ and a minimum at λ₂. A 157 nm beam is output from the output coupler and is incident at the amplifier of this embodiment to increase the power of the beam. Thus, a very narrow bandwidth beam is achieved with high suppression of the secondary line 2 and high power (at least several Watts to more than 10 Watts). An attenuator, which may be a variable aftenuator, may be included after the oscillator, preferably before the amplifier (see U.S. patent application Ser. No. 60/309,939, which is assigned to the same assignee as the present application and is hereby incorporated by reference), and alternatively after the amplifier.

The features of any of the embodiments of FIGS. 1a-10 may be combined to form advantageous alternative embodiments. In addition, some elements not particularly described or emphasized above may be included in alternative resonator arrangements that produce desired polarization and wavelength selectivity. For example, an interferometric device may be included for line-selection and/or line-narrowing. The device may be such as that described at any of the Ser. No. 09/715,803 or No. 60/280,398 applications, incorporated by reference above, or such as an etalon having parallel plates, which may or may not serve as a resonator reflector in addition to providing wavelength selectivity. A birefringent or non-birefringent half prism may be used not having the HR coating 66 or 72 of either of the prisms 64 or 70, respectively set forth above, and another element such as an HR mirror may serve as the resonator reflector. The full prism 42 with HR coating 44 as a resonator reflector may be included in other embodiments than that of FIG. 4a, and a non-birefringent full prism with HR coating may be used, where the loss of polarization selectivity is otherwise compensated by one or more other elements such as any of those set forth herein in other embodiments than FIG. 4a. A reflection or transmission grating or grism (see, e.g., the Ser. No. 09/738,849 application, incorporated by reference above) may also be included in alternative embodiments. One or more elements may be further included and/or the gas mixture pressure may be reduced, each as described above or as may otherwise be understood by those skilled in the art, for further narrowing the selected line. A beam expander may be included with any of the above embodiments, preferably just before a dispersive element such as a prism, grating or grism or before an interferometric device or an aperture.

While exemplary drawings and specific embodiments of the present invention have been described and illustrated, it is to be understood that that the scope of the present invention is not to be limited to the particular embodiments discussed. Thus, the embodiments shall be regarded as illustrative rather than restrictive, and it should be understood that variations may be made in those embodiments by workers skilled in the arts without departing from the scope of the present invention as set forth in the claims that follow, and equivalents thereof.

In addition, in the method claims that follow, the operations have been ordered in selected typographical sequences. However, the sequences have been selected and so ordered for typographical convenience and are not intended to imply any particular order for performing the operations, except for those claims wherein a particular ordering of steps is expressly set forth or understood by one of ordinary skill in the art as being necessary.

What is claimed is:

1. A method of generating a laser output beam around 157 nm using a molecular fluorine laser system including a discharge chamber filled with a gas mixture at least including molecular fluorine and a buffer gas, multiple electrodes within the discharge chamber and connected to a discharge circuit for energizing the gas mixture, and a resonator, comprising the operations:
operating the molecular fluorine laser system to generate the 157 nm output beam at a desired energy for exposing an application workpiece;
selecting a primary line among a plurality of characteristic photoemission lines around 157 nm of the molecular fluorine laser system including suppressing a secondary line among the plurality of characteristic photoemission lines around 157 nm to below 1%; and
polarizing the selected line so that the output beam has a polarization of at least substantially 95% when the beam exits the laser system.

2. The method of claim 1, wherein the polarizing operation includes polarizing the selected line so that the output beam has a polarization of at least substantially 97.5% when the beam exits the laser system.

3. A molecular fluorine laser system, comprising:
a discharge chamber filled with a gas mixture at least including molecular fluorine and a buffer gas;
multiple electrodes within the discharge chamber and connected to a discharge circuit for energizing the gas mixture; and
a resonator for generating an output beam, the resonator including at least one wavelength selection optic for selecting a primary line among a plurality of characteristic photoemission lines around 157 nm including suppressing a secondary line among the plurality of characteristic photoemission lines around 157 nm to below 1%, and at least one polarizing optic for polarizing the selected line so that the output beam has a polarization of at least substantially 97.5%.

4. The laser system of claim 3, wherein the at least one wavelength selection optic includes a non-birefringent, dispersive prism and the at least one polarizing optic includes a birefringent prism.

5. The laser system of claim 4, wherein the birefringent prism comprises MgF₂.

6. The laser system of claim 5, wherein the birefringent prism comprises a half-prism.

7. The laser system of claim 6, wherein the birefringent half-prism includes a HR coating as a resonator reflector surface.

8. The laser system of claim 5, wherein the birefringent prism comprises a dispersive, Brewster prism.

9. The laser system of claim 8, wherein the birefringent, dispersive, Brewster prism includes a HR coating as a resonator reflector surface.

10. The laser system of claim 4, wherein the non-birefringent, dispersive prism comprises CaF₂.

11. The laser system of claim 10, wherein the non-birefringent, dispersive prism comprises a Brewster prism.

12. The laser system of claim 10, wherein the non-birefringent, dispersive prism includes a HR coating as a resonator reflector surface.

13. The laser system of claim 4, wherein the birefringent prism comprises a dispersive, Brewster prism.

14. The laser system of claim 4, wherein the at least one wavelength selection optic further includes a second non-birefringent, dispersive prism.

15. The laser system of claim 14, wherein the birefringent prism comprises a half-prism.

16. The laser system of claim 15, wherein the birefringent half-prism includes a HR coating as a resonator reflector surface.

17. The laser system of claim 3, wherein the at least one wavelength selection optic includes at least two non-birefringent prisms.

18. The laser system of claim 17, wherein the at least two non-birefringent prisms comprise CaF₂.

19. The laser system of claim 18, wherein at least one of the at least two non-birefringent prisms comprises a dispersive Brewster prism, such that the at least one polarizing optic includes said at least one non-birefringent dispersive Brewster prism.

20. The laser system of claim 18, wherein the at least one polarizing optic includes a Brewster window.

21. The laser system of claim 18, wherein the at least one polarizing optic includes a Brewster stack.

22. The laser system of claim 4, further comprising a lens for correcting a wavefront curvature of the beam.

23. The laser system of claim 22, wherein the lens seals the discharge chamber.

24. The laser system of claim 22, wherein the lens includes a surface oriented at substantially Brewster's angle to the incident beam for performing polarization in addition to wavefront compensation.

25. The laser system of claim 4, further comprising an aperture within the resonator.

26. The laser system of claim 25, further comprising a second aperture within the resonator, wherein the two apertures are disposed on opposite sides of a discharge region defined between main discharge electrodes of the plurality of electrodes.

27. The laser system of claim 3, further comprising a lens for correcting a wavefront curvature of the beam.

28. The laser system of claim 27, wherein the lens seals the discharge chamber.

29. The laser system of claim 27, wherein the lens includes a surface oriented at substantially Brewster's angle to the incident beam for performing polarization in addition to wavefront compensation.

30. The laser system of claim 3, further comprising an aperture within the resonator.

31. The laser system of claim 30, further comprising a second aperture within the resonator, wherein the two apertures are disposed on opposite sides of a discharge region defined between main discharge electrodes of the plurality of electrodes.

32. The laser system of claim 3, further comprising an output coupler that seals the discharge chamber.

33. A molecular fluorine laser system, comprising:
a discharge chamber filled with a gas mixture at least including molecular fluorine and a buffer gas;
multiple electrodes within the discharge chamber and connected to a discharge circuit for energizing the gas mixture; and
a resonator for generating an output beam, the resonator including at least one wavelength selection optic including a non-birefringent prism for selecting a primary line among a plurality of characteristic photoemission lines around 157 nm including suppressing a secondary line among the plurality of characteristic photoemission lines around 157 nm to below 1%, and at least one polarizing optic including a birefringent prism for polarizing the selected line so that the output beam has a polarization of at least substantially 97.5%.

34. The laser system of claim 33, wherein the non-birefringent prism comprises CaF₂ and the birefringent prism comprises MgF₂.

35. The laser system of claim 33, further comprising a lens for correcting a wavefront curvature of the beam.

36. The laser system of claim 35, wherein the lens seals the discharge chamber.

37. The laser system of claim 35, wherein the lens includes a surface oriented at substantially Brewster's angle to the incident beam for performing polarization in addition to wavefront compensation.

38. The laser system of claim 33, further comprising an aperture within the resonator.

39. The laser system of claim 38, further comprising a second aperture within the resonator, wherein the two apertures are disposed on opposite sides of a discharge region defined between main discharge electrodes of the plurality of electrodes.

40. The laser system of claim 33, further comprising an output coupler that seals the discharge chamber.

41. A molecular fluorine laser system, comprising:
a discharge chamber filled with a gas mixture at least including molecular fluorine and a buffer gas;
multiple electrodes within the discharge chamber and connected to a discharge circuit for energizing the gas mixture; and
a resonator for generating an output beam, the resonator including at least one wavelength selection optic including a non-birefringent prism for selecting a primary line among a plurality of characteristic photoemission lines around 157 nm including suppressing a secondary line among the plurality of characteristic photoemission lines around 157 nm to below 1%, and at least one polarizing optic including multiple Brewster surfaces for polarizing the selected line so that the output beam has a polarization of at least substantially 97.5%.

42. The laser system of claim 41, wherein the non-birefringent prism comprises CaF₂.

43. The laser system of claim 42, wherein the non-birefringent prism comprises a dispersive, Brewster prism.

44. The laser system of claim 41, further comprising a lens for correcting a wavefront curvature of the beam.

45. The laser system of claim 44, wherein the lens seals the discharge chamber.

46. The laser system of claim 44, wherein the lens includes a surface oriented at substantially Brewster's angle to the incident beam for performing polarization in addition to wavefront compensation.

47. The laser system of claim 41, further comprising an aperture within the resonator.

48. The laser system of claim 47, further comprising a second aperture within the resonator, wherein the two apertures are disposed on opposite sides of a discharge region defined between main discharge electrodes of the plurality of electrodes.

49. The laser system of claim 41, further comprising an output coupler that seals the discharge chamber.

50. The laser system of claim 41, wherein said multiple Brewster surfaces include surfaces of one or more Brewster prisms.

51. The laser system of claim 41, wherein said multiple Brewster surfaces include surfaces of one or more Brewster plates.

52. The laser system of claim 41, wherein said multiple Brewster surfaces include a surface of a wavefront compensation lens.

53. The laser system of claim 41, wherein said multiple Brewster surfaces include surfaces of one or more Brewster windows.
